(19) United States
(12) Patent Application Publication
(10) Pub. No.: US 2011/0249755 A1
(43) Pub. Date: Oct. 13, 2011

(54) MOVING IMAGE CODING METHOD, MOVING IMAGE DECODING METHOD, MOVING IMAGE CODING APPARATUS, MOVING IMAGE DECODING APPARATUS, PROGRAM, AND INTEGRATED CIRCUIT

(76) Inventors: Youji Shibahara, Osaka (JP); Takahiro Nishi, Nara (JP); Hisao Sasai, Osaka (JP); Steffen Wittmann, Moerfelden-Walldorf (DE); Virginie Drugeon, Darmstadt (DE); Matthias Narroschke, Rodgau-Dudenhofen (DE)

(21) Appl. No.: 13/139,749

(22) PCT Filed: Dec. 16, 2009
(86) PCT No.: PCT/JP2009/006920

§ 371 Date: Jun. 15, 2011

(30) Foreign Application Priority Data
Dec. 16, 2008 (JP) 2008-320273
Dec. 24, 2008 (JP) 2008-328802

(51) Int. Cl. H04N 7/30

(52) U.S. Cl. 375/240.18; 375/E07.226

(57) ABSTRACT

The coding method includes: transforming pixel values of an image into a two-dimensional matrix including N coefficients in a frequency domain; quantizing the N coefficients to generate N quantized coefficients; generating a one-dimensional sequence based on the two-dimensional matrix and tree structure information that defines a binary tree; and coding the one-dimensional sequence and at least some of the N quantized coefficients. The generating includes: determining, based on the two-dimensional matrix, a reference destination information item indicating positions of the N quantized coefficients in the two-dimensional matrix to be referenced to by the N leaf nodes, respectively (S31); assigning one of a first value and a second value to each of the nodes of the binary tree, based on the two-dimensional matrix and the reference destination information item (S32); and arranging, in preorder, the values assigned to the respective nodes to generate the one-dimensional sequence (S33).

### TECHNICAL FIELD

The present invention relates to coding for compressing moving image data, and in particular, to a moving image coding method, a moving image decoding method, and apparatuses that performs the coding and decoding methods for achieving higher coding efficiency. Particularly, the present invention involves adaptively changing a method of describing positions of quantized non-zero coefficients.

### BACKGROUND ART

The moving image data is applied to various uses, such as video telephony, video conferencing, DVDs, and digital televisions. When the moving image data is transmitted or recorded, a considerable amount of data needs to be transmitted via a transmission channel having a limited available frequency range, or needs to be stored in a conventional recording medium having a limited data capacity. Thus, in order to transmit digital data to a conventional channel or store the data in a medium, compressing or reducing an amount of digital data is indispensable.

The video coding standards have been developed for compressing moving image data. Such video coding standards include, for instance, ITU-T standards denoted with H. 26x and ISO/IEC standards denoted with MPEG-x. The most up-to-date video coding standard is currently the standard denoted as the H.264/MPEG-4 AVC standard (NPL 1).

The coding approach underlying most of these standards consists of the following main stages.

(a) Dividing each individual video frame into pixel blocks of pixels in order to subject each video frame to data compression at a block level.

(b) Transforming each of the blocks in the moving image data from the spatial domain into the frequency domain.

(c) Reducing the overall amount of data by quantizing the resulting transform coefficients in the frequency domain.

(d) Entropy coding the quantized transform coefficients.

(e) Using the temporal dependence between blocks of consecutive frames for coding only change in the blocks of the consecutive frames. For these operations, the motion prediction and the compensation techniques are used.

It is a particular approach of the current video coding standards that the image information is transformed from the spatial domain into the frequency domain. Compressing information of an image is achieved by representing the image content by only a few frequency components. A natural image content is mostly concentrated in the coefficients of the lower frequency domain. Higher frequency components, for which the human visual system is less sensitive anyway, can thus be removed or quantized in order to reduce the amount of data to be coded.

The current moving image coding standards, such as MPEG-1, MPEG-2, MPEG-4, H.263, and H.264/AVC, use entropy coding for further compressing the quantized frequency coefficients.

The entropy coding includes a process for scanning a two-dimensional block of the quantized frequency coefficients to transform the two-dimensional quantized block into a one-dimensional sequence. There are cases where a predetermined method, such as the zig-zag scanning, or a zero-tree traversal method, is used (PTL 2).

FIG. 1 schematically illustrates the zig-zag scanning. Scanning a two-dimensional quantized transformation coefficient block 11 in a zig-zag scanning order 12 as illustrated in FIG. 1 results in obtainment of a one-dimensional sequence 13 of the quantized transformation coefficients. The scanning starts from the lowest frequency coefficient (that is, a DC coefficient), and ends simultaneously when all of, non-zero coefficients in the block are scanned. One of the problems of such a scanning method is to scan many non-zero coefficients until reaching the last non-zero coefficient.

The one-dimensional sequence of the obtained quantized transformation coefficients is separated into non-zero coefficients and zero coefficients. The non-zero coefficients are represented as a series of some pairs of levels and signs. The levels indicate absolute values, and the signs indicate plus and minus signs. FIG. 2 schematically illustrates the separation into non-zero coefficients and zero coefficients. Assuming that a quantized transformation coefficient block 21 having some 0 elements is an input, it is scanned and transformed into a one-dimensional sequence 22 as described above. The one-dimensional sequence 22 is separated into a binary sequence 23 indicating positions of the non-zero coefficients, and a non-zero coefficient sequence 24 that is a collection of non-zero coefficients.

In many of the applications, the amount of or the frequency range for storing or transferring coded moving image data is very limited. Thus, it is necessary to compress the moving image data as much as possible. However, reducing the amount of data and increasing the data compression rate through rougher quantization will degrade the image quality of the coded image.

Here, the frequency selective coding is known as a technique for reducing the redundancy of zero coefficients (PTL 1). The technique is a coding method and a decoding method, using the human visual features of being insensitive to a high frequency portion, thus allowing for suppression of the frequency of coding high-frequency coefficients and reduction in the amount of data of zero coefficients without coding any coefficients at particular high-frequency positions in the same frame.

FIG. 3 schematically illustrates the frequency selective coding (hereinafter abbreviated as FSC). In the two-dimensional quantized transformation coefficient block 11, only positions of a, b, e, and I are scanned in an FSC scanning order 32, and other positions are not scanned. Thereby, the number of resulting data items of a one-dimensional sequence 33 can be considerably reduced. Thus, cyclically coding frames in a high frequency range can suppress degradation in an image quality. FIG. 4 schematically illustrates cyclical coding of high frequency portions, and an example of coding a high frequency portion 6 in a frame f1, coding a high frequency portion 7 in a frame f2, and coding a high frequency portion 8 in a frame f3.

As described above, a coded amount of high-frequency coefficients is suppressed in FSC. However, without coding the high-frequency coefficients in an area (unit, such as block) where information about edges and others is large, there are cases where the degradation is visually recognizable.

The aforementioned zero-tree traversal method (PTL 2) will be described hereinafter. FIG. 5 schematically illustrates the zero-tree traversal method. In the zero-tree traversal method, a position of each coefficient in a quantized two-dimensional transformation coefficient block 61 is represented by a tree structure 62. The tree includes nodes. Among these, a node having a child node is referred to as an internal node, and a node having no child node is referred to as a leaf node.

When proceeding left-to-right in the depth-first search under this tree structure, the order of the traversed leaf nodes is determined as a zero-tree traversal order 65 for the quantized two-dimensional transformation coefficient block 61. Information indicating that a node has a valid value (whether an internal node has a child node, or a leaf node has a coefficient) in the traversal order is defined herein as a binary sequence 66 indicating valid nodes, or the binary sequence 66 indicating values of nodes.

In this example, the binary sequence 66 indicating valid nodes (or the binary sequence 66 indicating values of nodes) has elements of 1 as many as the number of the nodes. In this example, since all of the nodes are valid (all of the nodes indicate 1, that is, the leaf nodes have coefficients, and the internal nodes have valid child nodes), all of the elements are 1. However, when a certain leaf or an internal node is not valid, the element is 0. When an internal node is 0, the child node is not searched. In other words, since there is no need to describe a value relating to a node of a child (if the child has a child, also a value relating to a node of the child's child), the binary sequence 66 indicating the valid nodes becomes shorter.

For example, as illustrated in FIG. 6, a quantized transformation coefficient block 71 having some of the 0 elements is traversed in the tree structure 62. Here, since none of the child nodes of the node 73 has a value, the value of the node 73 is indicated as 0. When a node has 0 in decoding, it is found that the child node has no value. FIG. 6 indicates a binary sequence 72 indicating valid nodes as application of this example. Compared to the example in FIG. 5, it is found that the amount of data can be reduced.

As illustrated in FIGS. 5 and 6, the tree structure 62 is more complicated than the data structure of the zig-zag scanning. Thus, it has a larger processing amount in coding and decoding and needs a larger amount of memory. Thus, frequently coding all the data in the tree structure is redundant. However, when the frequency is selectively updated or in the case of FSC, it is necessary to update a position where a coefficient is hardly generated or a coefficient is not generated on a per-frame basis or others. Thus, the efficient data description is desired.

Furthermore, since the zig-zag scanning is performed in one raster, positions of non-zero coefficients can be located based on the number of zero coefficients that are not coded in FSC. However, since positions of coefficients are branched and then described, there is a problem that it is not easy to understand the positional relationship between the coefficients before and behind the zero coefficients that are not coded.

### CITATION LIST

### Patent Literature

[PTL 1] International Publication WO2006/118288
[PTL 2] US Patent Application 2006/0133680

### Non Patent Literature

[NPL 1] ITU-T Rec. H264, ISO/IEC 14496-10 version 1 “Information technology-Coding of audio-visual objects-Part 10: Advanced video coding”

### SUMMARY OF INVENTION

### Technical Problem

The present invention has an object of providing a moving image coding method, a moving image decoding method, and apparatuses that performs the coding and decoding methods for achieving a higher data compression rate without degrading image quality.

### Solution to Problem

The coding method according to an aspect of the present invention is a method of coding an image, and the method includes: transforming pixel values of the image into a two-dimensional matrix including N coefficients in a frequency domain, where N is an integer equal to or larger than 2; quantizing the N coefficients included in the two-dimensional matrix to generate N quantized coefficients; generating a one-dimensional sequence based on the two-dimensional matrix including the N quantized coefficients and on tree structure information that defines a binary tree including a plurality of nodes including an internal node and N leaf nodes; and coding the one-dimensional sequence generated in the generating, and at least some of the N quantized coefficients to generate a coded signal, wherein the generating includes: determining, based on the two-dimensional matrix, a reference destination information item indicating positions of the N quantized coefficients in the two-dimensional matrix to be referenced to by the N leaf nodes, respectively; assigning one of a first value and a second value to each of the nodes of the binary tree defined by the tree structure information, based on the two-dimensional matrix and the reference destination information item, the first value being different from the second value; and traversing the binary tree in preorder and arranging, in the preorder, the values assigned to the respective nodes to generate the one-dimensional sequence.

With the configuration, each time the one-dimensional sequence is generated, the reference destination information item is updated. Thereby, the coded amount of the one-dimensional sequence can be reduced. As a result, the decoding method having higher coding efficiency can be implemented. Furthermore, since there is no need to change the tree structure information itself, the processing load can be reduced.

According to an aspect of the present invention in the assigning: the first value may be assigned to one of the N leaf nodes corresponding to a quantized coefficient to be coded in the coding, and the second value may be assigned to an other one of the N leaf nodes corresponding to a quantized coefficient not to be coded in the coding, the quantized coefficient being held at a corresponding one of the positions of the two-dimensional matrix indicated in the reference destination information item; and the first value may be assigned to the internal node when the first value is assigned to at least one of two child nodes, and the second value may be assigned to the internal node when the second value is assigned to both of the two child nodes, in the traversing, when the second value is assigned to the internal node, traversing of a descendant node of the internal node may be omitted, and in the determining, the reference destination information item may be determined so that the one-dimensional sequence generated in the traversing is shortest. With the configuration, the coded amount can be reduced by updating the reference destination information item so that the one-dimensional sequence becomes the shortest.

Moreover, in the coding, the reference destination information item generated in the determining may be coded when the reference destination information item is different from an immediately previous reference destination information item. Thereby, the coding inefficiency can be suppressed, by coding the reference destination information only when it is updated.

Moreover, the reference destination information item may be an intermediate table for holding (i) position information items for identifying the positions of the two-dimensional matrix and (ii) indices for identifying the position information items, the position information items being associated with the indices, respectively, and the tree structure information may include structure information for identifying a structure of the binary tree, and index information indicating the indices to be referenced to by the N leaf nodes, respectively, the indices being held in the intermediate table. Since the influence on the decoding apparatus can be minimized, the legacy assets can be effectively used.

According to an aspect of the present invention, in the determining, combinations of the positions of the two-dimensional matrix and the indices may be changed so that one of the positions of the two-dimensional matrix at which a quantized coefficient to be coded is held is assigned to a leaf node that is traversed earlier than an other one of the positions of the two-dimensional matrix at which a quantized coefficient not to be coded is held. Thereby, the one-dimensional sequence can be the shortest.

According to an aspect of the present invention, in the coding, all non-zero quantized coefficients among the N quantized coefficients may be selected and coded. In another aspect, the two-dimensional matrix may be divided into a first group of quantized coefficients and a second group of quantized coefficients, and in the coding, all the quantized coefficients belonging to the first group may be coded, and only a quantized coefficient selected out of the second group according to values of the quantized coefficients belonging to the first group may be selected and coded.

The decoding method according to an aspect of the present invention is a method of decoding a coded signal to generate an image from a coded signal using tree structure information that defines a binary tree including a plurality of nodes including an internal node and N leaf nodes, where N is an integer equal to or larger than 2, and the method includes: decoding the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value; generating the two-dimensional matrix including N quantized coefficients, based on the one-dimensional sequence, the one or more quantized coefficients, the reference destination information item, and the tree structure information; inverse-quantizing the N quantized coefficients included in the two-dimensional matrix to generate N coefficients in a frequency domain; and inverse-transforming the N coefficients to generate pixel values of the image, wherein the generating includes: traversing the binary tree in preorder, assigning values indicated in the one-dimensional sequence to the nodes, respectively, and omitting traversing of a descendant node of the internal node when the second value is assigned to the internal node; and sequentially assigning, based on the reference destination information item, the one or more quantized coefficients to corresponding one or more of the positions of the two-dimensional matrix to be referenced to by corresponding one or more of the N leaf nodes to each of which the first value is assigned.

The coding apparatus according to an aspect of the present invention is a coding apparatus that codes an image, and includes: a transformation unit configured to transform pixel values of the image into a two-dimensional matrix including N coefficients in a frequency domain, where N is an integer equal to or larger than 2; a quantization unit configured to quantize the N coefficients included in the two-dimensional matrix to generate N quantized coefficients; a sequence generating unit configured to generate a one-dimensional sequence based on the two-dimensional matrix including the N quantized coefficients and on tree structure information that defines a binary tree including a plurality of nodes including an internal node and N leaf nodes; and a coding unit configured to code the one-dimensional sequence generated by the sequence generating unit, and at least some of the N quantized coefficients to generate a coded signal, wherein the sequence generating unit includes: a reference destination determining unit configured to determine, based on the two-dimensional matrix, a reference destination information item indicating positions of the N quantized coefficients in the two-dimensional matrix to be referenced to by the N leaf nodes, respectively; a value assigning unit configured to assign one of a first value and a second value to each of the nodes of the binary tree defined by the tree structure information, based on the two-dimensional matrix and the reference destination information item, the first value being different from the second value; and a traverse unit configured to traverse the binary tree in preorder and arrange, in the preorder, the values assigned to the respective nodes to generate the one-dimensional sequence.

The decoding apparatus according to an aspect of the present invention is a decoding apparatus that decodes a coded signal to generate an image from a coded signal using tree structure information that defines a binary tree including a plurality of nodes including an internal node and N leaf nodes, where N is an integer equal to or larger than 2, and the decoding apparatus includes: a decoding unit configured to decode the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value; a matrix generating unit configured to generate the two-dimensional matrix including N quantized coefficients, based on the one-dimensional sequence, the one or more quantized coefficients, the reference destination information item, and the tree structure information; an inverse quantization unit configured to inverse-quantize the N quantized coefficients included in the two-dimensional matrix to generate N coefficients in a frequency domain; and an inverse transformation unit configured to inverse-transform the N coefficients to generate pixel values of the image, wherein the matrix generating unit includes: an inverse traverse Unit configured to traverse the binary tree in preorder, assign values indicated in the one-dimensional sequence to the nodes, respectively, and omit traversing of a descendant node of the internal node when the second value is assigned to the internal node; and a coefficient assigning unit configured to sequentially assign, based on the reference destination information item, the one or more quantized coefficients to corresponding one or more of the positions of the two-dimensional matrix to be referenced to by corresponding one or more of the N leaf nodes to each of which the first value is assigned.

The program according to an aspect of the present invention is a program causing a computer to code an image and execute: transforming pixel values of the image into a two-dimensional matrix including N coefficients in a frequency domain, where N is an integer equal to or larger than 2; quantizing the N coefficients included in the two-dimensional matrix to generate N quantized coefficients; generating a one-dimensional sequence based on the two-dimensional matrix including the N quantized coefficients and on tree structure information that defines a binary tree including a plurality of nodes including an internal node and N leaf nodes; and coding the one-dimensional sequence generated in the generating, 1.0 and at least some of the N quantized coefficients to generate a coded signal, wherein the generating includes: determining, based on the two-dimensional matrix, a reference destination information item indicating positions of the N quantized coefficients in the two-dimensional matrix to be referenced to by the N leaf nodes, respectively; assigning one of a first value and a second value to each of the nodes of the binary tree defined by the tree structure information, based on the two-dimensional matrix and the reference destination information item, the ‘first value being different from the second value; and traversing the binary tree in preorder and arranging, in the preorder, the values assigned to the respective nodes to generate the one-dimensional sequence.

The program according to another aspect of the present invention is a program causing a computer to generate an image from a coded signal using tree structure information that defines a binary tree including a plurality of nodes including an internal node and N leaf nodes, where N is an integer equal to or larger than 2, and to execute: decoding the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value; generating the two-dimensional matrix including N quantized coefficients, based on the one-dimensional sequence, the one or more quantized coefficients, the reference destination information item, and the tree structure information; inverse-quantizing the N quantized coefficients included in the two-dimensional matrix to generate N coefficients in a frequency domain; and inverse-transforming the N coefficients to generate pixel values of the image, wherein the generating includes: traversing the binary tree in preorder, assigning values indicated in the one-dimensional sequence to the nodes, respectively, and omitting traversing of a descendant node of the internal node when the second value is assigned to the internal node; and sequentially assigning, based on the reference destination information item, the one or more quantized coefficients to corresponding one or more of the positions of the two-dimensional matrix to be referenced to by corresponding one or more of the N leaf nodes to each of which the first value is assigned.

The integrated circuit according to an aspect of the present invention is an integrated circuit that codes an image, and includes: a transformation unit configured to transform pixel values of the image into a two-dimensional matrix including N coefficients in a frequency domain, where N is an integer equal to or larger than 2; a quantization unit configured to quantize the N coefficients included in the two-dimensional matrix to generate N quantized coefficients; a sequence generating unit configured to generate a one-dimensional sequence based on the two-dimensional matrix including the N quantized coefficients and on tree structure information that defines a binary tree including a plurality of nodes including an internal node and N leaf nodes; and a coding unit configured to code the one-dimensional sequence generated by the sequence generating unit, and at least some of the N quantized coefficients to generate a coded signal, wherein the sequence generating unit includes: a reference destination determining unit configured to determine, based on the two-dimensional matrix, a reference destination information item indicating positions of the N quantized coefficients in the two-dimensional matrix to be referenced to by the N leaf nodes, respectively; a value assigning unit configured to assign one of a first value and a second value to each of the nodes of the binary tree defined by the tree structure information, based on the two-dimensional matrix and the reference destination information item, the first value being different from the second value; and a traverse unit configured to traverse the binary tree in preorder and arrange, in the preorder, the values assigned to the respective nodes to generate the one-dimensional sequence.

The integrated circuit according to another aspect of the present invention is an integrated circuit that generates an image from a coded signal using tree structure information that defines a binary tree including a plurality of nodes including an internal node and N leaf nodes, where N is an integer equal to or larger than 2, and the integrated circuit includes: a decoding unit configured to decode the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value; a matrix generating unit configured to generate the two-dimensional matrix including N quantized coefficients, based on the one-dimensional sequence, the one or more quantized coefficients, the reference destination information item, and the tree structure information; an inverse quantization unit configured to inverse-quantize the N quantized coefficients included in the two-dimensional matrix to generate N coefficients in a frequency domain; and an inverse transformation unit configured to inverse-transform the N coefficients to generate pixel values of the image, wherein the matrix generating unit includes: an inverse traverse unit configured to traverse the binary tree in preorder, assign values indicated in the one-dimensional sequence to the nodes, respectively, and omit traversing of a descendant node of the internal node when the second value is assigned to the internal node; and a coefficient assigning unit configured to sequentially assign, based on the reference destination information item, the one or more quantized coefficients to corresponding one or more of the positions of the two-dimensional matrix to be referenced to by corresponding one or more of the N leaf nodes to each of which the first value is assigned.

In order to solve the conventional problem of difficulty in managing the positional relationship between non-zero coefficients, the moving image coding method according to an aspect of the present invention using the frequency adaptive coding with the zero-tree traversal includes: orthogonally transforming pixels included in a block into coefficients in a frequency domain; quantizing the coefficients; coding the quantized coefficients into a position information item, levels, and signs; dividing the quantized coefficients into at least two coefficient groups; coding the position information item, the levels, and the signs of the first group; determining whether to select a subset of coefficients in the second group or the coefficients in the second group as a whole; and coding the position information item, the levels, and the signs of the selected coefficients.

According to an aspect of the present invention, immediately after coding the position information item of coefficients in the low frequency range, the coefficients in the low frequency range are coded, all the necessary information in a low-frequency portion is collected, and independent processes on a subsequent high-frequency portion and on data arrays are implemented. Thereby, understanding of the positional relationship between non-zero coefficients is facilitated even when zero coefficients are skipped.

The moving image decoding method according to an aspect of the present invention is a moving image decoding method of decoding coded data obtained by dividing pixels into blocks, and includes: decoding a position information item of non-zero coefficients in the blocks, based on presence and absence information of the non-zero coefficients and tree structure information of positions of the non-zero coefficients, and decoding levels and signs of the non-zero coefficients; integrating the position information item of the non-zero coefficients and the levels and signs to generate an integration signal; inverse-quantizing the integration signal to generate an inverse-quantized signal; and inverse-orthogonal transforming the inverse-quantized signal into pixel values, wherein the position information item of the non-zero coefficients in the blocks is decoded according to information of decoded non-zero coefficients obtained when the position information item of non-zero coefficients is determined.

Furthermore, the position information item of the non-zero coefficients in the block is decoded according to at least one of the following (i) to (iv): (i) the position information item of the decoded non-zero coefficients; (ii) the decoded integration signal; (iii) the decoded inverse-quantized signal; and (iv) a quantized parameter.

### ADVANTAGEOUS EFFECTS OF INVENTION

The moving image coding method according to the present invention enables easily changing the position of a coefficient without changing data (tree structure information) of a tree portion in the zero-tree structure. As a result, the moving image coding method having higher coding efficiency can be implemented.

### BRIEF DESCRIPTION OF DRAWINGS

FIG. 1 schematically illustrates the conventional zig-zag scanning.

FIG. 2 schematically illustrates the conventional separation into non-zero coefficients and zero coefficients.

FIG. 3 schematically illustrates the conventional frequency selective coding (FSC).

FIG. 4 schematically illustrates temporal changes in the conventional frequency selective coding (FSC).

FIG. 5 schematically illustrates the conventional zero-tree traversal method.

FIG. 6 schematically illustrates the conventional zero-tree traversal method.

FIG. 7 schematically illustrates a method of updating only the correspondence between leaves and coefficient positions according to Embodiment 1 of the present invention.

FIG. 8 schematically illustrates an intermediate memory for updating only the correspondence between leaves and coefficient positions according to Embodiment 1 of the present invention.

FIG. 9 illustrates a block diagram of a moving image coding apparatus according to Embodiment 1.

FIG. 10 illustrates a flowchart of operations of the moving image coding apparatus in FIG. 9.

FIG. 11 illustrates a block diagram of a moving image decoding apparatus according to Embodiment 1.

FIG. 12 illustrates a flowchart of operations of the moving image decoding apparatus in FIG. 11.

FIG. 13 illustrates a block diagram of a sequence generating unit according to Embodiment 1.

FIG. 14 illustrates a block diagram of a matrix generating unit according to Embodiment 1.

FIG. 15A is a flowchart indicating the moving image coding method according to Embodiment 1.

FIG. 15B is a flowchart indicating the moving image decoding method according to Embodiment 1.

FIG. 16 is a flowchart of a sequence generating process according to Embodiment 1.

FIG. 17 illustrates the sequence generating process in FIG. 16.

FIG. 18 is a flowchart of a matrix generating process according to Embodiment 1.

FIG. 19 schematically illustrates the matrix generating process in FIG. 18.

FIG. 20 schematically illustrates data relating to a tree structure generated in the moving image coding method according to Embodiment 2.

FIG. 21 is a flowchart indicating the moving image coding method according to Embodiment 2.

FIG. 22A is a flowchart indicating the moving image coding method according to Embodiment 2.

FIG. 22B is a flowchart indicating the operating procedure of the moving image decoding apparatus according to Embodiment 2.

FIG. 23 schematically illustrates the local adaptive FSC according to Embodiment 3.

FIG. 24 schematically illustrates data relating to a tree structure generated in the moving image coding method according to Embodiment 4.

FIG. 25 schematically illustrates data relating to a tree structure generated in the moving image coding method according to Embodiment 4.

FIG. 26 is a flowchart for performing the moving image coding method according to Embodiment 4.

FIG. 27 schematically illustrates data relating to a tree structure generated in the moving image coding method according to Embodiment 5.

FIG. 28 illustrates a zero-tree decoding unit that updates the tree structure according to decoded data, and the peripheral block diagram according to Embodiment 5.

FIG. 29 is a flowchart indicating the operating procedure of the zero-tree decoding unit that updates the tree structure according to decoded data, in Embodiment 5.

FIG. 30 schematically illustrates searching the tree structure including nodes each having values according to Embodiment 6.

FIG. 31 is a flowchart indicating the operating procedure for searching the tree structure including nodes each having values according to Embodiment 6.

FIG. 32 schematically illustrates data relating to a tree structure generated in the moving image coding method according to Embodiment 7.

FIG. 33 illustrates data arrays of binary sequences and non-zero coefficient sequences according to Embodiment 7.

FIG. 34A is a flowchart indicating the moving image coding method according to Embodiment 7.

FIG. 34B is a flowchart indicating the moving image decoding method according to Embodiment 7.

FIG. 35 schematically illustrates an example of zero-tree structures having no information indicating a coefficient position according to Embodiment 7.

FIG. 36 schematically illustrates an example of coding a sequence indicating coefficient positions according to Embodiment 8.

FIG. 37 schematically illustrates an overall configuration of a content providing system for implementing content distribution services.

FIG. 38 illustrates an external view of a cellular phone.

FIG. 39 is a block diagram illustrating an example of a configuration of a cellular phone.

FIG. 40 schematically illustrates an example of an overall configuration of a digital broadcasting system.

FIG. 41 is a block diagram illustrating an example of a configuration of a television.

FIG. 42 is a block diagram illustrating an example of a configuration of an information reproducing/recording unit that reads and writes information from or on a recording medium that is an optical disk.

FIG. 43 illustrates an example of a configuration of a recording medium that is an optical disk.

FIG. 44 is a block diagram illustrating an example of a configuration of an integrated circuit for implementing the image coding method and the image decoding method according to each of Embodiments.

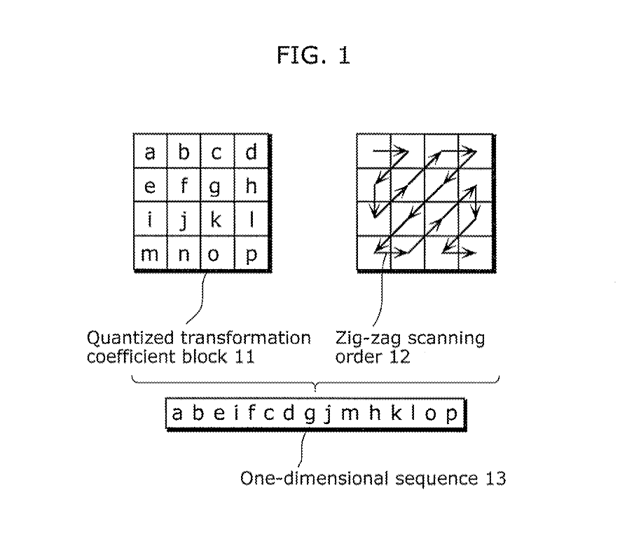

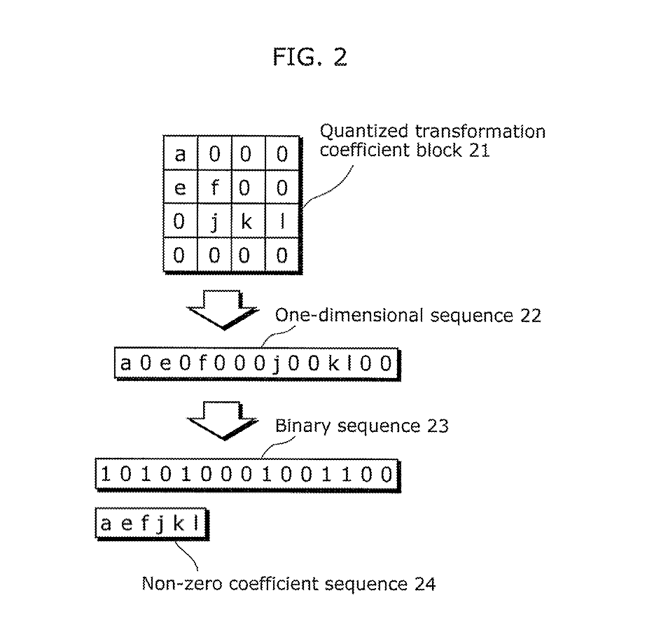

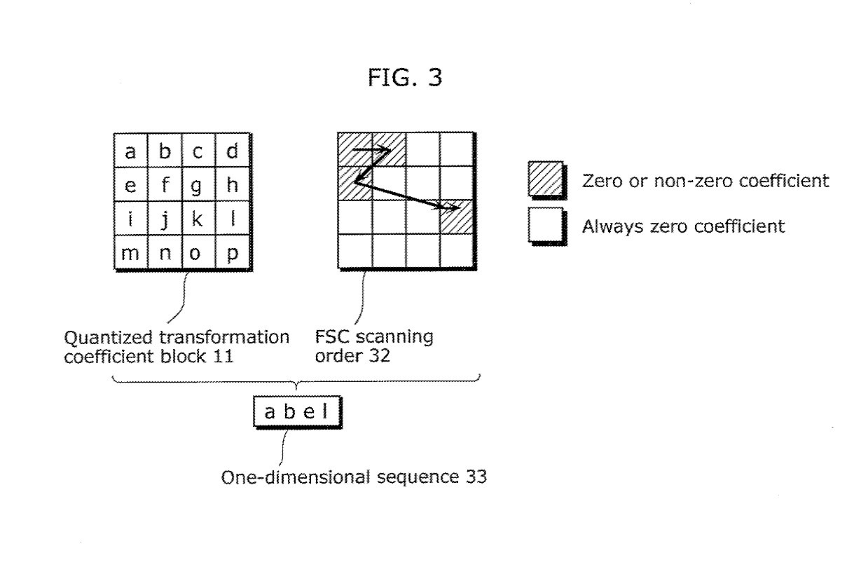

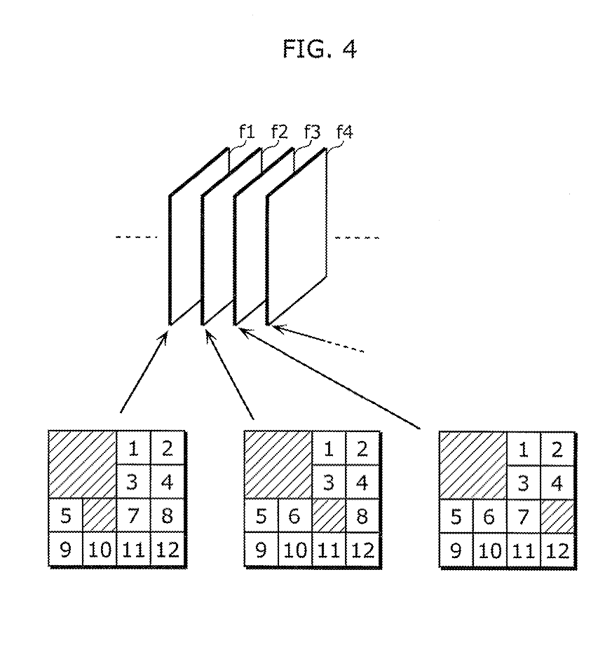

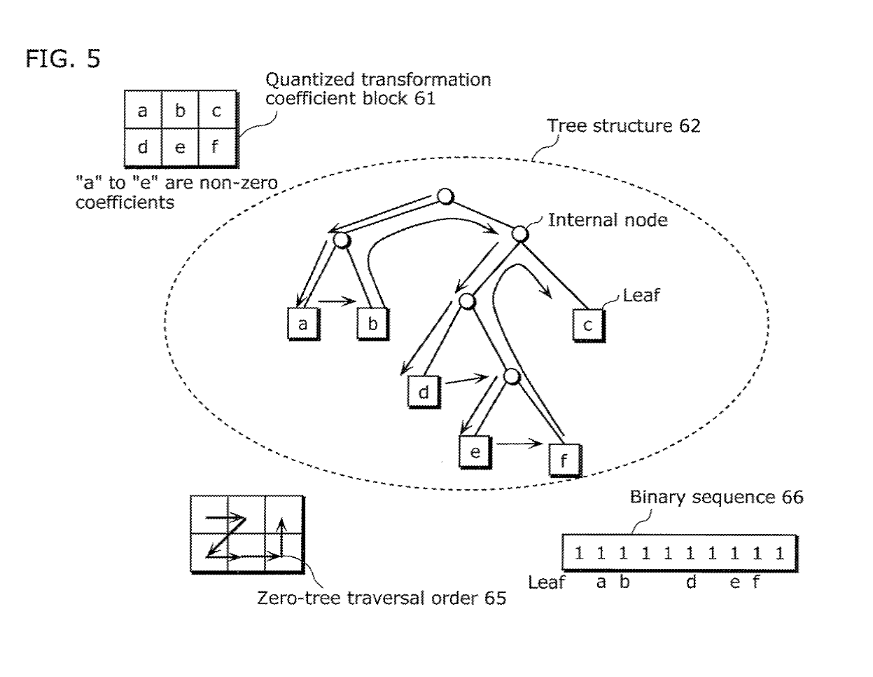

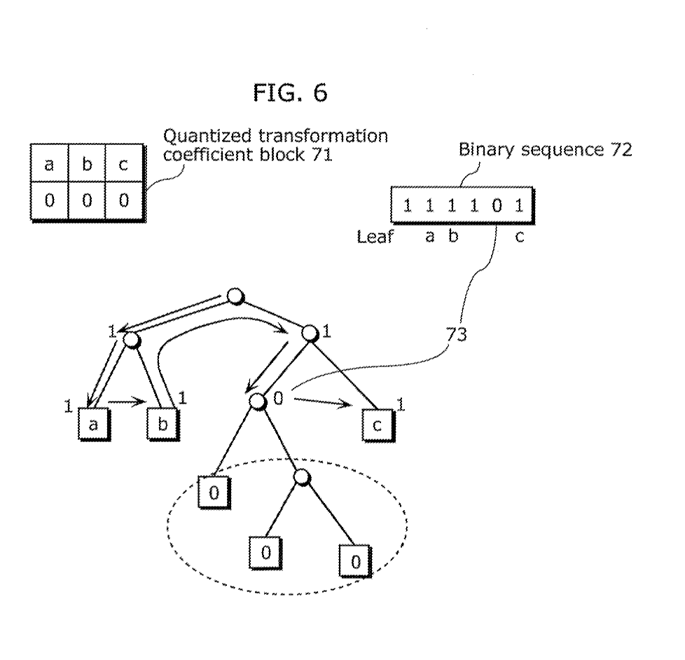

### DESCRIPTION OF EMBODIMENTS

### Embodiment 1

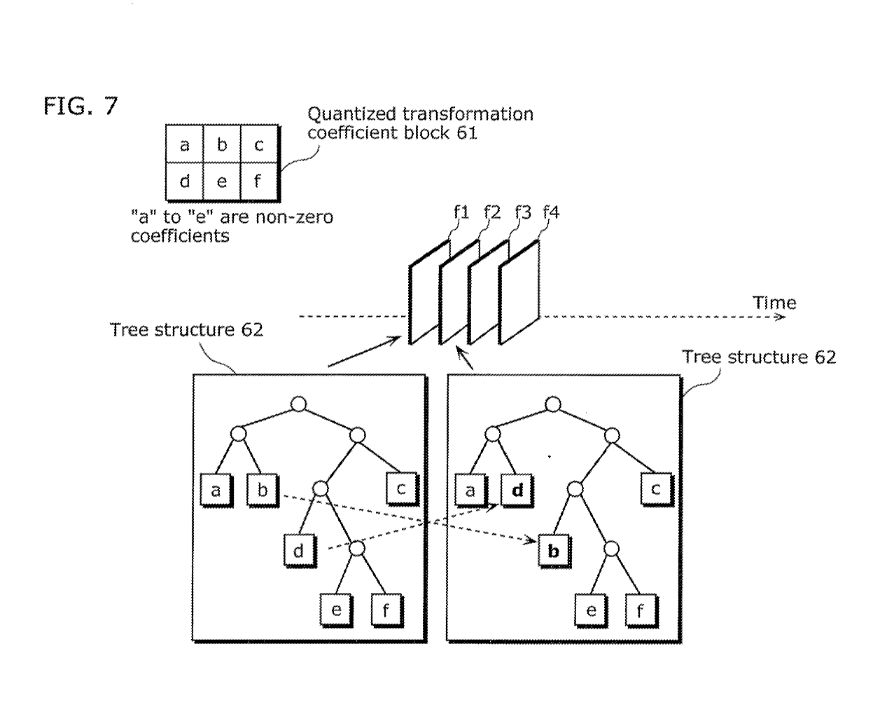

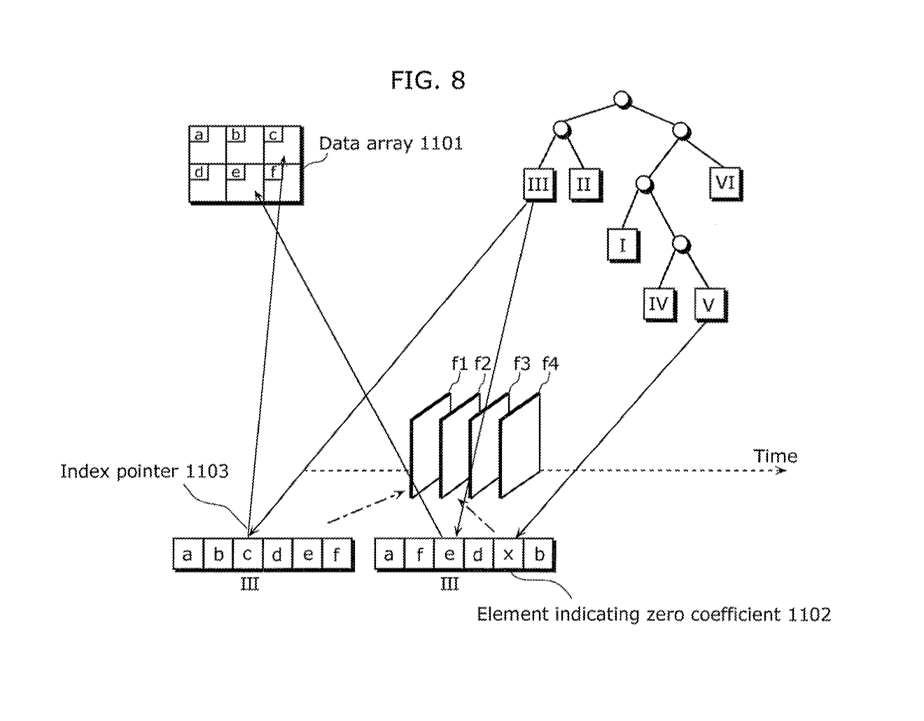

First, the idea of a coding method and a decoding method according to Embodiment 1 of the present invention will be described with reference to FIGS. 7 and 8. As described above, a position where a coefficient is not generated varies at least on a per-frame basis when the frequency is selectively updated. Since a tree structure 62 is complicated, frequently updating the tree structure 62 is redundant. In order to address the problem, only the positional correspondence between leaf nodes and the coefficients is updated without changing the relation of connection between the nodes in the tree structure 62, as illustrated in the schematic diagram in FIG. 7.

Furthermore, as illustrated in the schematic diagram in FIG. 8, only the position information item of the coefficients can be updated by providing a data array 1101 for sorting (also referred to as reference destination information item) to the positional correspondence between the leaf nodes and the coefficients. A value of a leaf node indicates an order within the data array 1101, and the element corresponding to the value indicates a coefficient position.

In this example, the position of the leaf node indicated by III is obtained with reference to the third element in the data array 1101. The third element in the data array 1101 at the frame f1 indicates the coefficient position “a”. On the other hand, the third element in the data array 1101 at the frame f2 indicates the coefficient position “b”.

The data array can be easily generated because of no complexity as in a tree structure. In other words, the position information item indicated by a leaf node is an indirect position information item, and indicates a position in the data array 1101. The element value in the data array 1101 indicates the position information item of a coefficient.

Furthermore, by assigning a value other than the coefficient positions “a” to “f” in the block, such as an element indicating a zero coefficient 1102 in FIG. 8, the leaf node indicating the element (node having V) can indicate having no non-zero coefficient. In this case, since none of the elements of an index pointer 1103 indicates the coefficient position f, it is found that the coefficient position f does not have any non-zero coefficient, that is, the coefficient is 0.

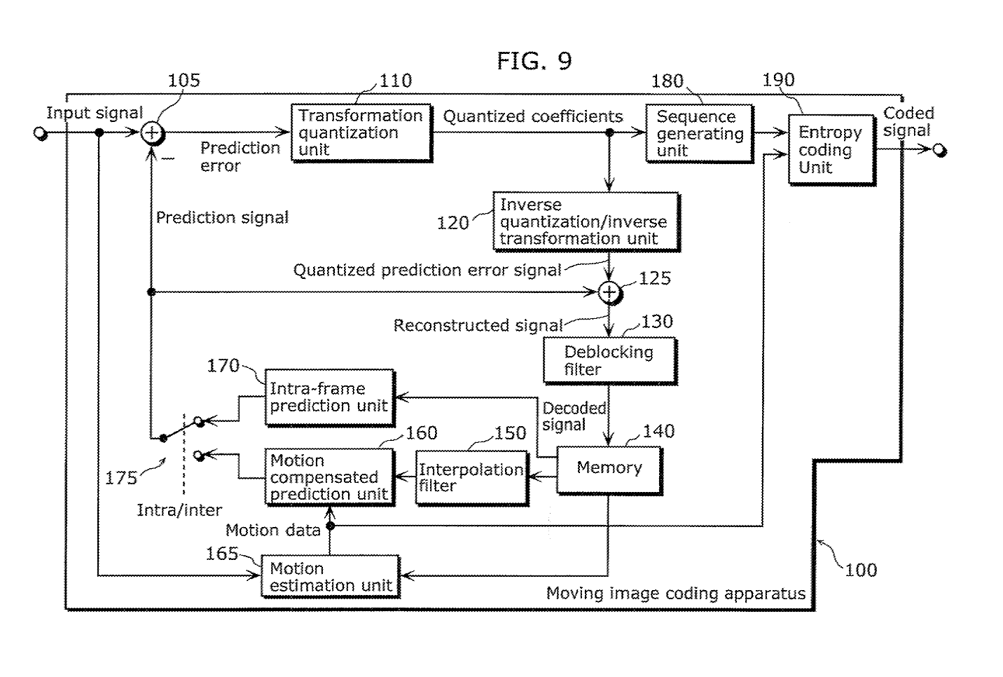

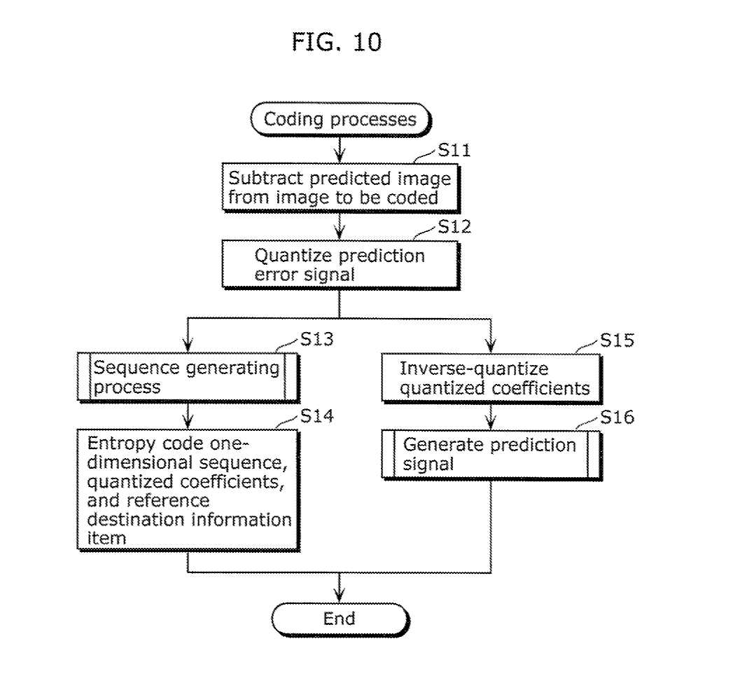

Next, a moving image coding apparatus 100 according to Embodiment 1 of the present invention will be described with reference to FIGS. 9 and 10. FIG. 9 illustrates a functional block diagram of the moving image coding apparatus 100. FIG. 10 illustrates a flowchart of operations of the moving image coding apparatus 100.

As illustrated in FIG. 9, the moving image coding apparatus 100 includes a subtractor 105, a transform quantization unit 110, an inverse quantization/inverse transformation unit 120, an adder 125, a deblocking filter 130, a sequence generating unit 180, an entropy coding unit 190, an output unit that outputs a coded signal (omitted in FIG. 9), and a predicted block generation unit (omitted in FIG. 9).

The moving image coding apparatus 100 codes a moving image signal as an input signal, and outputs a coded signal. The output destination is not limited. For example, the moving image coding apparatus 100 may output the signal to a recording medium, such as a Digital Versatile Disc (DVD) and a Blu-ray Disc (BD), or transfer the signal to a moving image decoding apparatus 200 through a transmission channel.

The subtractor 105 subtracts a predicted block (prediction signal) from a current block to be coded (input signal) to generate a prediction error signal. The transform quantization unit 110 performs discrete cosine transformation (DCT) on the prediction error signal, and quantizes the resulting signal to generate a quantized coefficient. More specifically, the transform quantization unit 110 transforms pixel values of a moving image signal into a two-dimensional matrix including N coefficients in a frequency domain, where N is equal to or larger than 2. Then, it quantizes the N coefficients included in the two-dimensional matrix to generate N quantized coefficients.

The sequence generating unit 180 divides the two-dimensional matrix including the N quantized coefficients into a one-dimensional sequence and quantized coefficients. The detailed operations of the sequence generating unit 180 will be described later. The entropy coding unit 190 entropy codes the one-dimensional sequence and others outputted from the sequence generating unit 180 to generate a coded signal.

The inverse quantization/inverse transformation unit 120 inverse-quantizes and performs inverse DCT transformation on the quantized coefficient outputted from the transform quantization unit 110 to generate a quantized prediction error signal. The adder 125 adds the quantized prediction error signal to the prediction signal to generate a reconstructed signal. The deblocking filter 130 reduces blocking artifacts from the reconstructed signal to generate a decoded signal.

The predicted block generation unit generates the prediction signal predicted from the current block (input signal), based on the coded image prior to coding of the current block. The predicted block generation unit includes a memory 140, an interpolation filter 150, a motion estimation unit 165, a motion compensated prediction unit 160, an intra-frame prediction unit 170, and an intra/inter switch 175.

The memory unit 140 functions as a delay unit that temporarily stores the decoded signal. More specifically, the blocks quantized by the transform quantization unit 110 and inverse quantized by the inverse quantization/inverse transformation unit 120 are sequentially stored in the memory 140 to store an image (picture). The interpolation filter 150 spatially interpolates a pixel value of the decoded signal prior to the motion compensated prediction. The motion estimation unit 165 performs motion estimation based on the decoded signal and the next block to be coded to generate motion data (a motion vector). The motion compensated prediction unit 160 performs motion compensated prediction based on the decoded signal and the motion data to generate the prediction signal. The intra-frame prediction unit 170 intra-predicts the decoded signal to generate the prediction signal. The intra/inter switch 175 selects one of the intra-prediction mode and the inter-prediction mode as a prediction mode. Then, the predicted block provided from the intra/inter switch 175 becomes a signal obtained by predicting the next block to be coded.

Next, the operations of the moving image coding apparatus 100 will be described with reference to FIG. 10.

First, the subtractor 105 subtracts a prediction signal from an input signal to generate a prediction error signal (S11). Next, the transform quantization unit 110 performs DCT on and quantizes the prediction error signal to generate quantized coefficients (S12). Here, the transform quantization unit 110 outputs a two-dimensional matrix including the N quantized coefficients (typically, 8×8=64).

Next, the sequence generating unit 180 executes a sequence generating process for converting the two-dimensional matrix outputted from the transform quantization unit 110 into a one-dimensional sequence (S13). The details of the sequence generating process will be described later. Next, the entropy coding unit 190 entropy codes the one-dimensional sequence, the quantized coefficients, the motion data, a reference destination information item (described later), and others to generate a coded signal (S14).

In parallel with the operation by the entropy coding unit 190, the inverse quantization/inverse transformation unit 120 inverse-quantizes the quantized coefficients outputted from the transform quantization unit 110, and performs inverse DCT transformation on the resulting signal to generate a quantized prediction error signal. Furthermore, the adder 125 adds the quantized prediction error signal to the prediction block to generate a reconstructed signal. The deblocking filter 130 reduces blocking artifacts from the reconstructed signal to generate a decoded signal. Then, the predicted block generation unit generates a predicted block based on the decoded signal (S16).

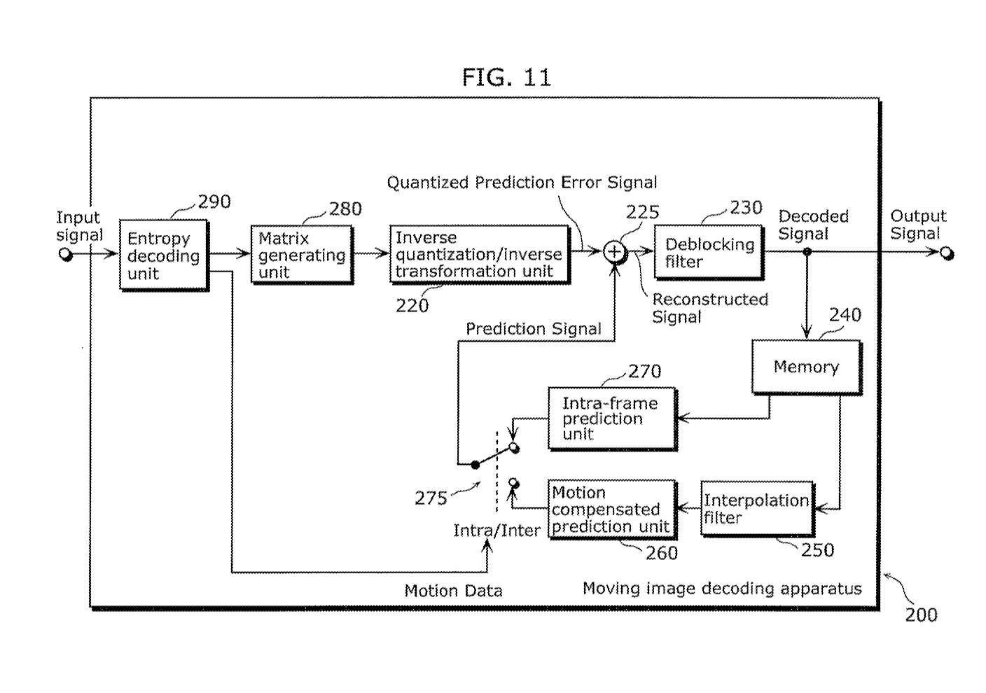

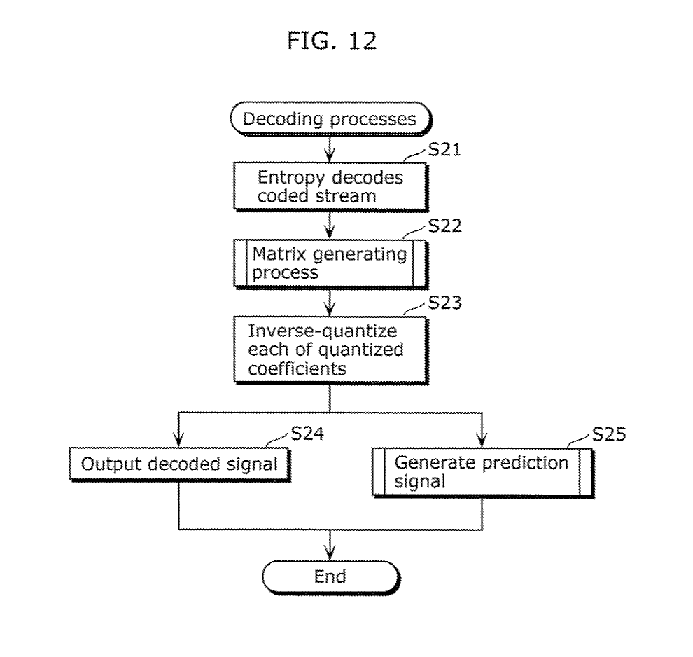

Next, the moving image decoding apparatus 200 according to Embodiment 1 of the present invention will be described with reference to FIGS. 11 and 12. FIG. 11 illustrates a block diagram of the moving image decoding apparatus 200. FIG. 12 illustrates a flowchart of operations of the moving image coding apparatus 200.

As illustrated in FIG. 11, the moving image decoding apparatus 200 includes an obtaining unit that obtains a coded signal, an entropy decoding unit 290, a matrix generating unit 280, an inverse quantization/inverse transformation unit 220, an adder 225, a deblocking filter 230, and a predicted block generation unit (not illustrated). The moving image decoding apparatus 200 decodes the coded signal obtained by the moving image coding apparatus 100 in FIG. 9 to generate a decoded block (decoded signal).

The entropy decoding unit 290 entropy decodes the coded signal outputted from the moving image coding apparatus 100 to obtain the one-dimensional sequence, the quantized coefficients, the motion data, and the reference destination information item. The matrix generating unit 280 generates the two-dimensional matrix including the N quantized coefficients by combining the one-dimensional sequence and the quantized coefficients. The detailed operations of the matrix generating unit 280 will be described later.

The inverse quantization/inverse transformation unit 220 inverse-quantizes and performs inverse DCT transformation on each of the quantized coefficients of the two-dimensional matrix outputted from the matrix generating unit 280 to generate a quantized prediction error signal. The adder 225 adds the quantized prediction error signal outputted from the inverse quantization/inverse transformation unit 220, to the prediction signal outputted from the predicted block generation unit to generate a reconstructed signal. The deblocking filter 230 is applied to the reconstructed signal outputted from the adder 225, and smoothes the block edges, thus leading to an improved subjective image quality of the decoded image.

The predicted block generation unit includes a memory 240, an intra-frame prediction unit 270, a motion compensated prediction unit 260, an interpolation filter 250, and an intra/inter switch 275. Although the predicted block generation unit in the moving image decoding apparatus 200 has the same basic configuration and performs the same operations as the predicted block generation unit in the moving image decoding apparatus 100, it is different by omitting the motion prediction unit 165 and in that the motion data is obtained from the entropy decoding unit 290.

Next, the operations of the moving image decoding apparatus 200 will be described with reference to FIG. 12.

First, the entropy decoding unit 290 entropy decodes the coded signal to obtain the one-dimensional sequence, the quantized coefficients, the motion data, and the reference destination information item (S21). Next, the matrix generating unit 280 executes a matrix generating process for generating a two-dimensional matrix by combining the one-dimensional sequence and the quantized coefficients (S22). The details of the matrix generating process will be described later.

Next, the inverse quantization/inverse transformation unit 220 inverse-quantizes and performs inverse DCT transformation on each of the quantized coefficients of the two-dimensional matrix outputted from the matrix generating unit 280 to generate a quantized prediction error signal (S23). Next, the adder 225 adds the quantized prediction error signal to the prediction block to generate a reconstructed signal. Furthermore, the deblocking filter 230 reduces blocking artifacts from the reconstructed signal to generate a decoded signal. Then, the moving image decoding apparatus 200 outputs the decoded signal (typically, displays the decoded signal on a display) (S24). On the other hand, the predicted block generation unit generates the prediction signal using the reconstructed signal (S25).

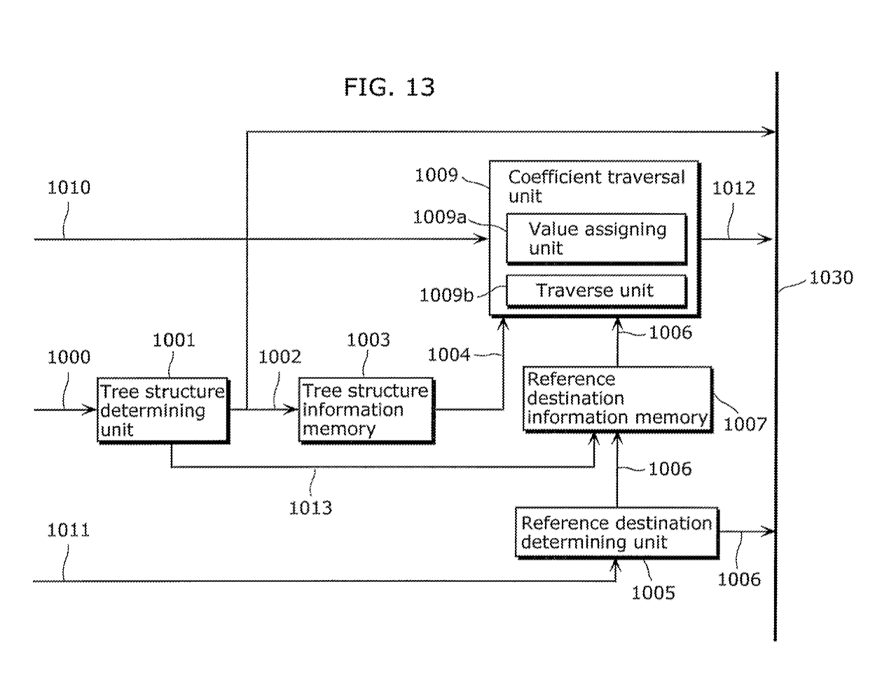

FIG. 13 illustrates a block diagram of the sequence generating unit 180 according to Embodiment 1. The sequence generating unit 180 includes a tree structure determining unit 1001, a tree structure information memory 1003, a reference destination determining unit 1005, a reference destination information memory 1007, and a coefficient traversal unit 1009.

The tree structure determining unit 1001 determines tree structure information 1002 based on predetermined structure information 1000, occurrence frequency or intensity information of a coefficient of a frame or a slice that has been immediate previously coded, or others. The tree structure determining unit 1001 stores the determined tree structure information 1002 in the tree structure information memory 1003, and outputs the tree structure information 1002 to a storage medium or a transmission channel 1030. Simultaneously, the tree structure determining unit 1001 determines an initial value of the reference destination information item 1013 to be stored in a leaf node, and stores the initial value in the reference destination information memory 1007.

Here, the tree structure information 1002 is information for defining a binary tree (also referred to as zero tree) including nodes including an internal node and N leaf nodes. The reference destination information item 1013 is an information item indicating the positions of the two-dimensional matrix to be referenced to by the N leaf nodes, respectively.

The two-dimensional matrix including the N quantized coefficients are fed to the coefficient traversal unit 1009. The coefficient traversal unit 1009 traverses coefficients in the zero-tree traversal method, based on the tree structure information 1004 read from the tree structure information memory 1003 and the reference destination information item 1006 read from the reference destination information memory 1007, converts the coefficients into a binary sequence indicating valid nodes and level and sign information 1012 of non-zero coefficients, and outputs the binary sequence and the level and sign information 1012 to the storage medium or the transmission channel 1030.

More specifically, the coefficient traversal unit 1009 generates a one-dimensional sequence based on the tree structure information 1004, the reference destination information item 1006, and the two-dimensional matrix 1010 including the N quantized coefficients. The coefficient traversal unit 1009 includes a value assigning unit 1009a and a traverse unit 1009b.

The value assigning unit 1009a assigns one of a first value and a second value to each of the nodes of the binary tree defined by the tree structure information 1004. Here, the first value is different from the second value. In Embodiment 1, the first value is 1, and the second value is 0.

When the entropy coding unit 190 codes a quantized coefficient held at a position of the two-dimensional matrix indicated in the reference destination information item 1013, the value assigning unit 1009a assigns 1 to one of the N leaf nodes corresponding to the quantized coefficient. When the entropy coding unit 190 does not code the quantized coefficient, the value assigning unit 1009a assigns 0 to a corresponding one of the N leaf nodes. Next, when assigning 1 to at least one of two child nodes, the value assigning unit 1009a assigns 1 to the internal node. When assigning 0 to both of the two child nodes, the value assigning unit 1009a assigns 0 to the internal node.

The traverse unit 1009b traverses the binary tree in preorder, and arranges the values assigned to the respective nodes in the preorder to generate the one-dimensional sequence. Here, when 0 is assigned to an internal node, the traverse unit 1009b omits the traversing of a descendant node of the internal node.

Upon receipt of a trigger signal 1011 that triggers sorting, the reference destination determining unit 1005 generates a new reference destination information item 1006. Then, the reference destination determining unit 1005 overwrites the reference destination information memory 1007 with the new reference destination information item 1006, and outputs the new reference destination information item 1006 to the storage medium or the transmission channel 1030 at the same time. Here, the trigger signal 1011 that triggers sorting is used when a position of a high-frequency coefficient to be updated is changed or others in adaptively and selectively updating the frequency. Here, the reference destination determining unit 1005 determines the reference destination information item 1006 such that 0 is assigned to a higher-ranked internal node (that is, so that a one-dimensional sequence becomes shorter) through the process by the value assigning unit 1009a.

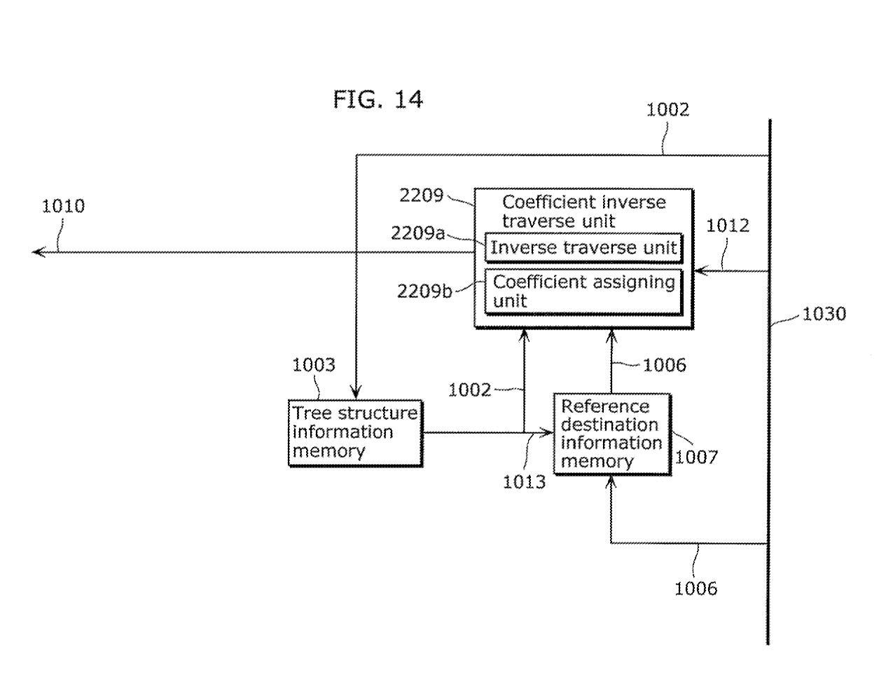

FIG. 14 illustrates a block diagram of the matrix generating unit 280 according to Embodiment 1. The matrix generating unit 280 includes the tree structure information memory 1003, the reference destination information memory 1007, and a coefficient inverse traverse unit 2209.

The tree structure information memory 1003 receives and stores the tree structure information 1002 through the storage medium or the transmission channel 1030 with a relatively long period of a frame, a slice, or blocks. The stored tree structure information 1002 is outputted to the coefficient inverse traverse unit 2209. There are cases where the tree structure information 1002 has an initial value of the reference destination information item 1013 indicating the positional correspondence between leaf nodes and coefficients. When the tree structure information 1002 has the initial value, the tree structure information 1002 is stored in the reference destination information memory 1007. Upon receipt of a new reference destination information item 1006 with equal frequency or on a per-block basis, the reference destination information memory 1007 is overwritten with the new reference destination information item 1006.

The coefficient inverse traverse unit 2209 receives the level and sign information 1012 of non-zero coefficients and the binary sequence indicating valid nodes, determines positions of the non-zero coefficients according to the binary sequence indicating the valid nodes, based on the tree structure information 1002 and the reference destination information item 1006, integrates levels and signs of the non-zero coefficients into the two-dimensional matrix 1010 including the N quantized coefficients, and outputs the two-dimensional matrix 1010.

More specifically, the coefficient inverse traverse unit 2209 generates the two-dimensional matrix 1010 including the N quantized coefficients, based on the one-dimensional sequence, the quantized coefficients, the reference destination information item 1006, and the tree structure information 1002. The coefficient inverse traverse unit 2209 includes an inverse traverse unit 2209a and a coefficient assigning unit 2209b.

The inverse traverse unit 2209b traverses the binary tree in preorder, and assigns the values indicated by the one-dimensional sequence to the nodes, respectively. Here, when 0 is assigned to an internal node, the inverse traverse unit 2209b omits traversing of a descendant node of the internal node. The coefficient assigning unit 2209b sequentially assigns quantized coefficients to positions of the two-dimensional matrix referenced to by the leaf nodes to each of which 0 is assigned, based on the reference destination information item 1006.

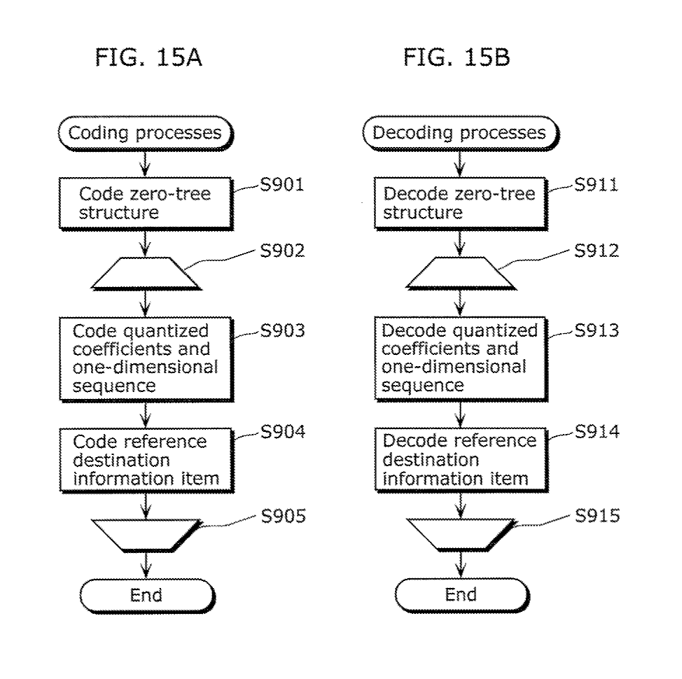

FIG. 15A is a flowchart indicating the operating procedure of the moving image coding apparatus 100 according to Embodiment 1. First, the entropy coding unit 190 codes and outputs the tree structure information 1002 generated by the tree structure determining unit 1001 (S901). Since the tree structure information 1002 is relatively large in amount, it is generally generated once and then outputted.

Next, in the repetitive operations on a per-frame basis, on a per-slice basis, or on a per-blocks basis (S902 to S905), quantized coefficients of one or more blocks and a one-dimensional sequence are coded (S903). Furthermore, when a position of a coefficient is changed in adaptively updating the frequency, the reference destination information item 1006 of the coefficient of the leaf node is coded (S904). Then, the entropy coding unit 190 codes these information items and outputs them as a coded stream (also referred to as coded signal). When a frame or a slice to be coded still remains, or blocks to be coded still remain, each of the coefficient is again coded (S903). The reference destination information item may be updated (S904) before coding the quantized coefficient (S903).

Furthermore, although there is a position of a coefficient that is not coded in the FSC, the absence of the valid position of a coefficient may be represented by a particular value in sorting the position information items (for example, assigning “−1.”, or assigning 16 when 0 to 15 are assigned to coefficient positions in the block having 16 coefficients of 4×4). When such an invalid position is assigned to a value of a leaf node and the other one of the child nodes belonging to the parent indicates 0, it is necessary to rewrite the value of the parent to 0. The rewriting operation is performed from all of the leaf nodes to the root.

FIG. 15B is a flowchart indicating the operating procedure of the moving image coding apparatus 200 according to Embodiment 1. First, a coded stream is decoded into the tree structure information (S911). Next, in the repetitive operations on a per-frame basis, on a per-slice basis, or on a per-blocks basis (S912 to S915), quantized coefficients and a one-dimensional sequence are decoded (S913). Furthermore, when information for updating the reference destination information item 1006 of coefficients of leaf nodes is included in the coded stream, the reference destination information item 1006 in the reference destination information memory 1007 is updated (S914).

When coded data that has not yet been decoded remains in the coded stream (S915), the decoding process is continued (S912). Here, the orders between the decoding of the reference destination information item 1006 (S914) and the decoding of the quantized coefficients and the one-dimensional sequence (S913) may be changed.

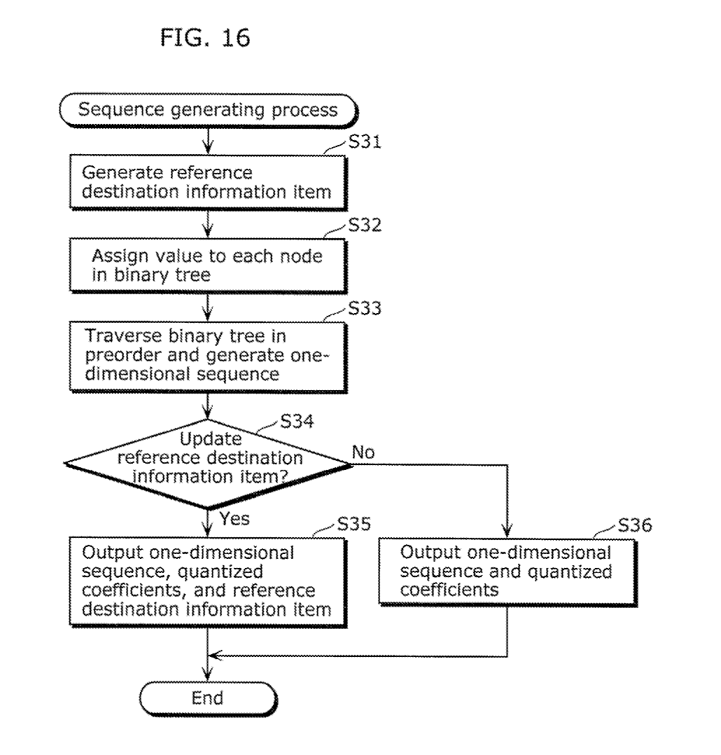

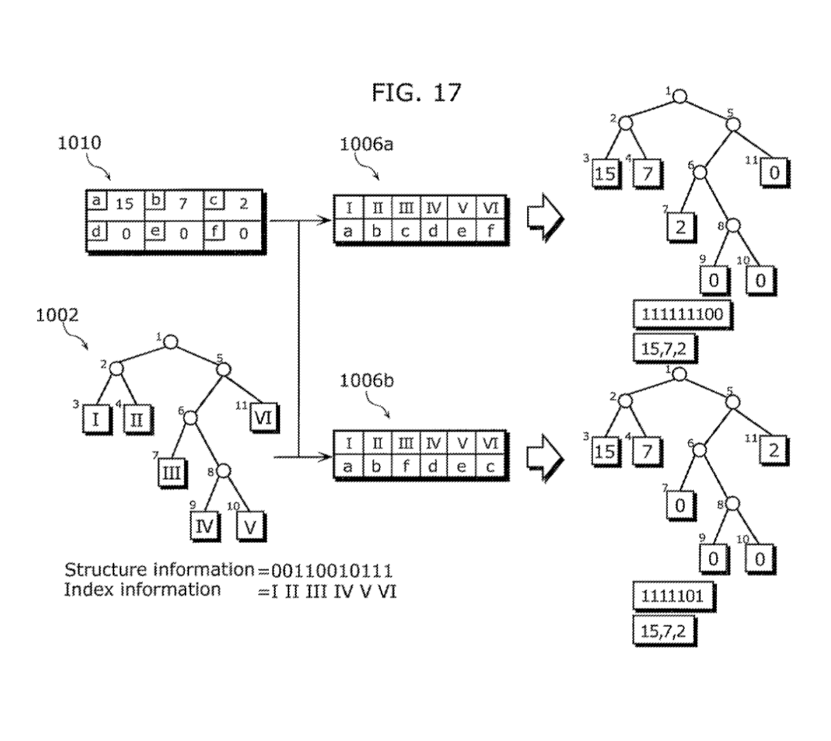

Next, an example of the sequence generating process according to Embodiment 1 will be described with reference to FIGS. 16 and 17. FIG. 16 is a flowchart of the sequence generating process. FIG. 17 illustrates an example of data generated by the sequence generating process.

The two-dimensional matrix 1010 includes the N quantized coefficients. Furthermore, FIG. 17 indicates positions of cells in the two-dimensional matrix 1010 respectively by numerals “a” to “f”. Although FIG. 17 illustrates the example of the two-dimensional matrix 1010 including six quantized coefficients for simplification, the present invention is not limited to this example. For example, the two-dimensional matrix 1010 may be a 4×4 matrix (16 cells) or a 8×8 matrix (64 cells).

The tree structure information 1002 is information for defining the structure of a binary tree. Although the detailed data structure is not particularly limited, the tree structure information 1002 includes, for example, structure information (ztree_structure) and index information (ztree_leaf_index).

The structure information is information for identifying the structure of the binary tree, and indicates, for example, the sort order of internal nodes and leaf nodes when the binary tree is traversed in preorder. Here, traversing in the preorder means traversing each subtree included in the binary tree in the order of “parent node to left node to right node” or “parent node to right node to left node”. In the example of FIG. 17, 0 indicates an internal node, and 1 indicates a leaf node. The index information indicates indices of an intermediate table (to be described later) to be referenced to by N leaf nodes. In the binary tree of FIG. 17, a value X at the left corner of each node indicates the traversal order of the node. Hereinafter, a particular node is denoted as “node (x)”.

Then, the reference destination determining unit 1005 generates the reference destination information item 1006 based on the two-dimensional matrix 1010 and the tree structure information 1002 (S31). FIG. 17 indicates reference destination information items 1006a and 1006b that are specific examples of the reference destination information item 1006. Each of the reference destination information items 1006a and 1006b is the intermediate table for holding position information items indicating positions (“a” to “f”) in the two-dimensional matrix and indices (I to VI) for identifying the position information items, where the position information items are associated with the indices. The indices (I to VI) correspond to the index information of the tree structure information 1002. In other words, each of the leaf nodes in the binary tree accesses the two-dimensional matrix 1010 via the reference destination information items 1006a and 1006b.

Here, the reference destination determining unit 1005 generates the reference destination information item 1006 such that the one-dimensional sequence to be generated is the shortest. In other words, the combinations of the position information items indicating the positions of the two-dimensional matrix and the indices are changed. For example, the reference destination determining unit 1005 generates the reference destination information item 1006 such that 0 is assigned to a higher-ranked internal node through the process by the value assigning unit 1009a. Furthermore, the reference destination determining unit 1005 generates the reference destination information item 1006 such that one of the positions of the two-dimensional matrix at which a quantized coefficient to be coded is held is assigned to a leaf node that is traversed earlier than that of the position of the two-dimensional matrix at which a quantized coefficient not to be coded is held.

Although the method of determining the reference destination information item 1006 is not particularly limited, for example, the reference destination information items 1006a and 1006b are prepared in advance, and a one-dimensional sequence is generated based on each of the reference destination information items 1006a and 1006b, so that the reference destination information item 1006 with which the shortest one-dimensional sequence can be generated may be selected from among the reference destination information items 1006a and 1006b. Alternatively, a new reference destination information item 1006b may be generated by generating a one-dimensional sequence based on the reference destination information item 1006a immediate previously generated and changing the combinations of the position information items and the indices of the reference destination information 1006a so that a one-dimensional sequence shorter than the generated one-dimensional sequence can be generated.

First, a process for generating a one-dimensional sequence using the reference destination information item 1006a will be described.

The value assigning unit 1009a assigns one of 1 and 0 to each node of the binary tree defined by the tree structure information 1002 (S32).

First, a value is assigned to each of N leaf nodes. More specifically, when a quantized coefficient held in the two-dimensional matrix 1010 indicated by the reference destination information 1006a is coded, 1 is allocated to the quantized coefficient. On the other hand, when the quantized coefficient is not coded, 0 is allocated to the quantized coefficient. In Embodiment 1, only quantized non-zero coefficients are coded.

For example, the index at the node 3 is I, and the position “a” is associated with the index I in the reference destination information item 1006a. Since the quantized coefficient at the position “a” is 15 and is to be coded, 1 is assigned to the node 3. On the other hand, the index at the node 11 is VI, and the position “f” is associated with the index VI in the reference destination information item 1006a. Since the quantized coefficient at the position “f” is 0 and is not to be coded, 0 is assigned to the node 11.

Next, values are assigned to the internal nodes. More specifically, when 1 is assigned to at least one of two child nodes, 1 is assigned to the internal node. On the other hand, when 0 is assigned to both of the two child nodes, 0 is assigned to the internal node.

For example, 1 is assigned to the nodes 3 and 4 that are child nodes of the node 2. In other words, 1 is assigned to the node 2. On the other hand, 0 is assigned to the nodes 9 and 10 that are child nodes of the node 8. In other words, 0 is assigned to the node 8.

Next, the traverse unit 1009b traverses, in preorder, the binary tree in which a value is assigned to each node, and arranges the values assigned to the respective nodes in the preorder (S33). As a result, a one-dimensional sequence (111111100) can be obtained, using the reference destination information item 1006a. Furthermore, a sequence of the quantized coefficients to be coded is determined as (15, 7, 2).

Next, the process for generating a one-dimensional sequence using the reference destination information item 1006b will be described. Here, the reference destination information item 1006b is different from the reference destination information 1006a in that the index III is associated with the position “f” and the index VI is associated with the position “c”. Since the process for generating a one-dimensional sequence is described hereinbefore, the description is not repeated. The one-dimensional sequence (1111101) can be obtained, using the reference destination information item 1006b. Furthermore, a sequence of the quantized coefficients to be coded is determined as (15, 7, 2).

As apparent with reference to FIG. 17, when the reference destination information item 1006a is used, 0 is assigned to the node 8. On the other hand, when the reference destination information item 1006b is used, 0 is assigned to the node 6. In other words, 0 can be assigned to a higher-ranked internal node using the reference destination information item 1006b.

Furthermore, the one-dimensional sequence generated using the reference destination information item 1006a is 9 bits long. In contrast, the one-dimensional sequence generated using the reference destination information item 1006b is 7 bits long. In other words, a shorter one-dimensional sequence can be obtained; using the reference destination information item 1006b.

Next, the sequence generating unit 180 determines whether or not the generated (used) reference destination information item 1006b is different from the reference destination information item immediate previously generated (used) (that is, updated or not) (S34). When the generated reference destination information item 1006b is different from that previously generated (Yes at S34), the sequence generating unit 180 outputs, to the entropy coding unit 190, the one-dimensional sequence, the sequence of the quantized coefficients, and the reference destination information item 1006b (S35). Here, the entropy coding unit 190 may code overall the reference destination information item 1006b or only a difference between the reference destination information item 1006b and the reference destination information item 1006a immediate previously generated.

When the generated reference destination information item 1006b is the same as that previously generated (No at S34), the sequence generating unit 180 outputs, to the entropy coding unit 190, the one-dimensional sequence and the sequence of the quantized coefficients (S36).

With the configuration, the amount of data coded by the entropy coding unit 190 can be reduced. Furthermore, since the aforementioned processes can be performed only by changing the reference destination information item 1006 without changing the tree structure information 1002 having a larger amount of data, the processing load will not significantly increase.

The tree structure information 1002 according to Embodiment 1 includes the structure information (ztree_structure) and the index information (ztree_leaf_index). Furthermore, the reference destination information item 1006 is an intermediate table for holding position information items for identifying positions in the two-dimensional matrix 1010 and indices (I to VI) for identifying the position information items, where the position information items are associated with the indices. However, another structure may be used in which the intermediate table is omitted and the index information in the tree structure information 1002 is optimized (that is, the index information is equivalent to the reference destination information item).

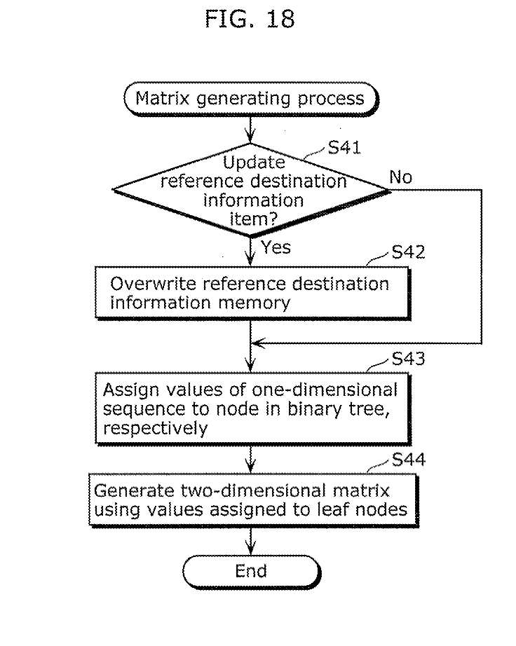

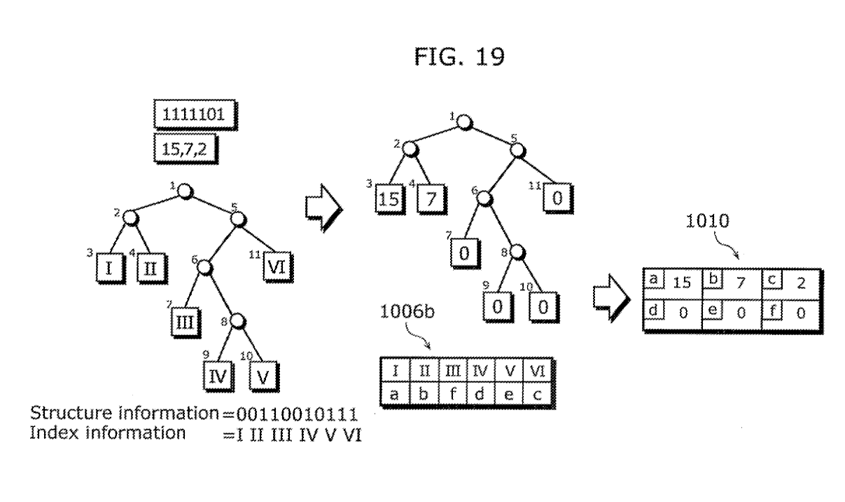

Next, an example of the matrix generating process according to Embodiment 1 will be described with reference to FIGS. 18 and 19. FIG. 18 is a flowchart of the matrix generating process. FIG. 19 illustrates an example of data generated by the matrix generating process.

First, the matrix generating unit 280 obtains a signal outputted from the entropy decoding unit 290. The signal includes the one-dimensional sequence (1111101), the sequence of the quantized to coefficients (15, 7, 2), and a new reference destination information 1006b that are generated by the moving image coding apparatus 100.

Here, when the signal outputted from the entropy decoding unit 290 includes the reference destination information item 1006b, that is, when the reference destination information item 1006 is updated (Yes at S41), the matrix generating unit 280 overwrites the reference destination information memory 1007 with the new reference destination information item 1006b (S42). On the other hand, when the signal outputted from the entropy decoding unit 290 does not include the reference destination information item 1006, the matrix generating unit 280 omits the process at S42.

Next, the inverse traverse unit 2209a traverses the binary tree in preorder, and assigns the values indicated by the one-dimensional sequence to the nodes, respectively (S43). However, when 0 is assigned to an internal node, the inverse traverse unit 1009b omits traversing of a descendant node of the internal node.

The inverse traverse process (S43) will be hereinafter described with reference to FIG. 19. First, each value of the one-dimensional sequence is assigned to a corresponding node. More specifically, 1 is assigned to the nodes 1 to 5, and 0 is assigned to the node 6. Since 0 is assigned to the node 6 that is an internal node, traversing of the nodes 7 to 10 that are descendant nodes of the node 6 (assigning of values) is omitted. In other words, the last value “1” of the one-dimensional sequence is assigned to the node 11.

Next, the coefficient assigning unit 2209b sequentially assigns each of the coefficients included in the sequence of the quantized coefficients, to a position of the two-dimensional matrix referenced to by the leaf node to which 1 is assigned, based on the reference destination information item 1006b (S44). Thereby, the two-dimensional matrix is generated.

The leaf nodes to each of which 1 is assigned in the inverse traverse process (S43) are the nodes 3, 4, and 11. Furthermore, the index I in the reference destination information item 1006b is assigned to the node 3, the index II is assigned to the node 4, and the index VI is assigned to the node 11. Here, the coefficient assigning unit 2209b assigns the first coefficient “15” among the sequence of the quantized coefficients, to the position “a” in the two-dimensional matrix to be referenced to by the node 3 via the reference destination information item 1006b. Similarly, the coefficient assigning unit 2209b assigns the quantized coefficient “7” to the position “b” to be referenced to by the node 4, and the quantized coefficient “2” to the position “c” to be referenced to by the node 11. On the other hand, the quantized coefficient 0 is assigned to the positions “d”, “e”, and “f” to be referenced to by the leaf nodes (nodes 9, 10, and 7, respectively) to which 0 is assigned.

With the structure, since a two-dimensional matrix can be reconstructed from a one-dimensional sequence only by changing the reference destination information item 1006 without changing the tree structure information 1002 having a larger amount of data, the processing load will not significantly increase.

### Embodiment 2

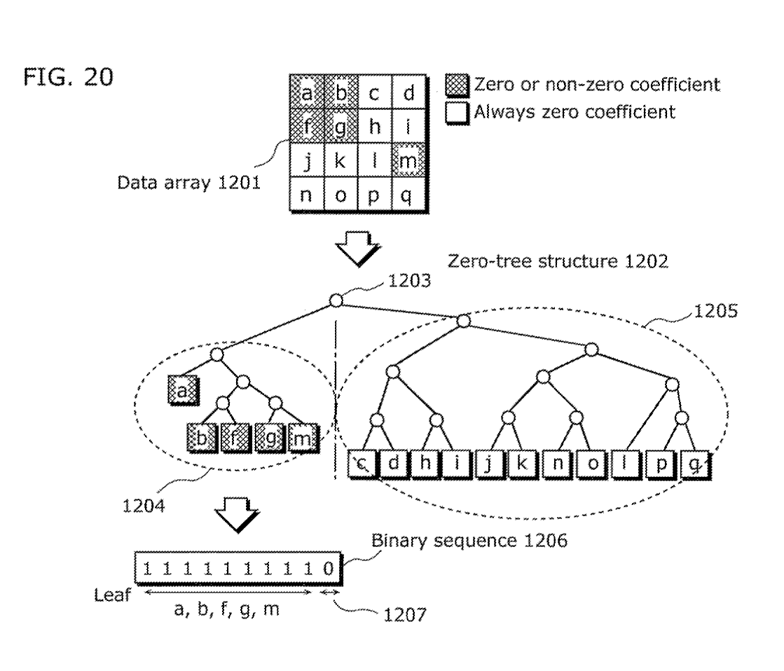

Next, a moving image coding apparatus 100 and a moving image decoding apparatus 200 according to Embodiment 2 of the present invention will be described with reference to FIGS. 20 to 22B. Since the configuration and the basic operations of the moving image coding apparatus 100 and the moving image coding apparatus 200 are to the same as those of Embodiment 1, the detailed description will be omitted hereinafter.

Although Embodiment 1 describes an example in which only quantized non-zero coefficients in a two-dimensional matrix are coded, the present invention is not limited to the example. For example, quantized coefficients to be coded may be selected using the frequency selective coding.

In other words, a two-dimensional matrix is divided, in advance, into the first group of quantized coefficients and the second group of quantized coefficients. Then, the entropy coding unit 190 codes all the quantized coefficients belonging to the first group, and selects and codes only a quantized coefficient from the second group according to values of the quantized coefficients belonging to the first group. Then, the sequence generating unit 180 has only to distinguish between the quantized coefficient to be coded and the quantized coefficient not to be coded, based on the rule.

As described above, when the frequency is selectively updated, although low-frequency coefficients and only a part of high-frequency coefficients are coded, the rest of many coefficients are not coded. In this case, with respect to a parent node 1203 in a zero-tree structure 1202, a position possibly having a non-zero coefficient is assigned to the child to be traversed first (in this example, a left subtree 1204 according to the priority order from the left to the right), and all positions having no non-zero coefficient are assigned to the child to be traversed second (in this example, a right subtree 1205) as illustrated in the schematic diagram in FIG. 20.

The state possibly having a non-zero coefficient does not always mean a zero state, because there are cases where the states include both non-zero and zero states. Generally, the coefficients having no non-zero coefficient are many when the frequency is selectively updated. However, a partial sequence 1207 relating to the non-zero coefficients in the binary sequence (one-dimensional sequence) 1206 can have the minimum number of the coefficients (1 in this example), by collecting positions of the coefficients having no non-zero coefficient.

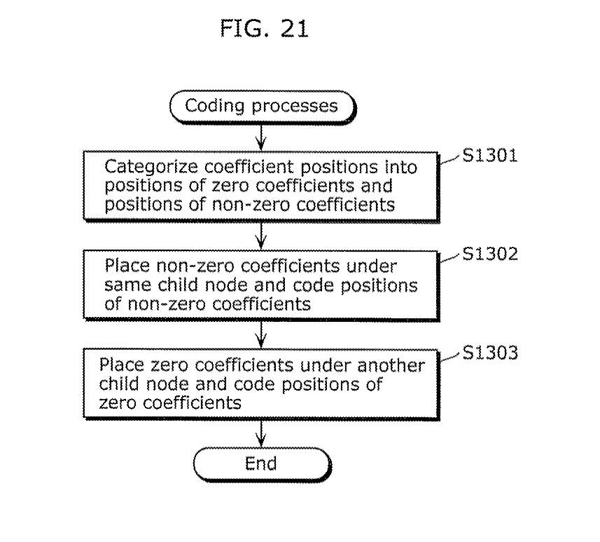

The moving image coding apparatus 100 according to Embodiment 2 determines the zero-tree structure as indicated in the flowchart in FIG. 21. First, coefficient positions are categorized into coefficient positions always having zero coefficients and coefficient positions possibly having non-zero coefficients (S1301). Next, the coefficient positions possibly having non-zero coefficients are first placed under the same child node and coded (S1302). Next, the coefficient positions always having zero coefficients are placed under another child node and coded (S1303). Thereby, the amount of data of the binary sequence indicating valid nodes can be minimized.

Moreover, the sequence generating process described with reference to FIGS. 16 and 17 is also applicable to the moving image coding apparatus 100 according to Embodiment 2. In other words, the reference destination determining unit 1005 of the sequence generating unit 180 determines the reference destination information 1006 so that a non-zero coefficient to be coded is assigned to the left subtree 1204, and a zero coefficient not to be coded is assigned to the right subtree 1205. Thereby, a one-dimensional sequence in the frequency selective coding can be minimized.

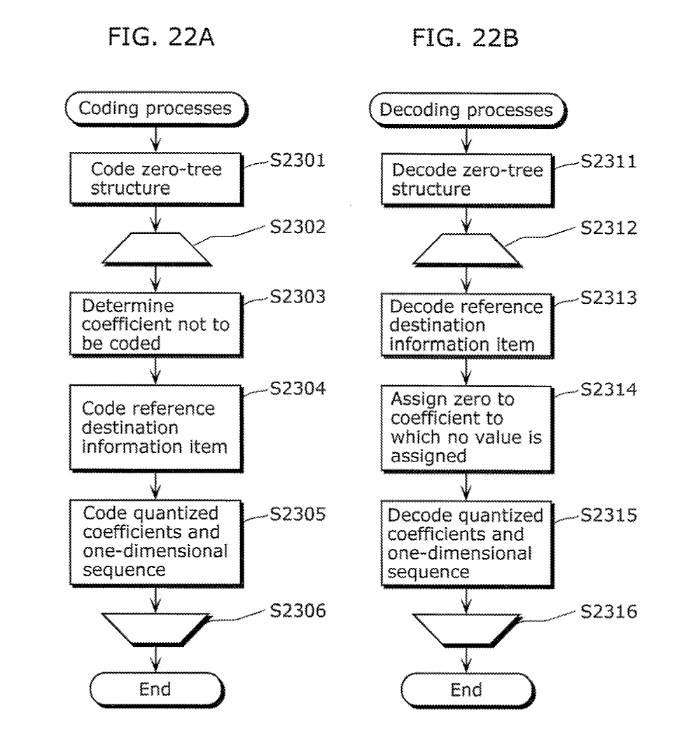

FIG. 22A is a flowchart indicating the operating procedure of the moving image coding apparatus according to Embodiment 2. FIG. 22A is a modification of FIG. 15A, and includes a process for notifying, when a coefficient at a particular position is not to be coded in the FSC, the coefficient position not to be coded.

A zero-tree structure is coded (S2301). The value of a leaf node in the zero-tree structure does not directly indicate a coefficient position, but an indirect position information item indicating the position information item of the coefficient through a data array for sorting.

Next, in the repetitive operations on a per-frame basis, on a per-slice basis, or on a per-blocks basis (S2302), a coefficient position not to be coded is determined (S2303). On the other hand, the coefficient position not to be coded is represented in a state where the to coefficient position is not referenced to by a leaf node in a zero tree. For example, the position update information represented by a special value (−1 or a value exceeding the total of coefficients in a block) is coded into a data array for sorting (S2304).

Next, the quantized coefficients only at coefficient positions possibly having coefficients to be coded are coded (S2305). The processes S2303 to S2305 will be repeated according to S2301 (S2306). The process for coding the position update information at S2304 is omitted when the information indicates the same position information as the previous frame, slice, or blocks. Furthermore, the zero-tree structure at S2301 may be coded during the iteration of the processes S2302 to S2306.

FIG. 22B is a flowchart indicating the operating procedure of the moving image decoding apparatus according to Embodiment 2. FIG. 22B is a modification of FIG. 15B, and includes a process for notifying, when a coefficient at a particular position is not to be coded in the FSC, the coefficient position not to be coded.

The zero-tree structure is decoded (S2311), so that all of the leaf nodes are decoded into the relationship indicating elements in a data array for sorting (that is, the indirect position information item). In the repetitive operations on a per-frame basis, on a per-slice basis, or on a per-blocks basis (S2312), the current position information item is updated when the position update information is present, and otherwise, the position information item is determined using the previous position information item (S2313).

Here, when an element, indicated by the indirect position information item assigned to a leaf node, in the data array for sorting is a special value representing a coefficient position not to be coded (−1 or a value exceeding the total of coefficients in a block), the value of the leaf node is determined as 0. When the value of the other child node belonging to the parent node and determined as 0 is 0, the parent node is also determined as 0.

Next, the values of all of the nodes are rewritten towards the root (S2313). Furthermore, when there is a coefficient position that is not indicated by any element in the data array for sorting, it is determined that the coefficient is not to be coded, and 0 is assigned to the coefficient (S2314).

Next, the quantized coefficients are set to the original coefficient positions in accordance with the inverse of the zero-tree traversal order. According to the decoding method in the present invention, what a leaf node in a zero tree indicates is not a direct coefficient position but an indirect position information item. In other words, it indicates an element in a data array for sorting. What the element in a data array for sorting indicates the ultimate position information item of the coefficient (S2315). Steps S2313 to 2315 are iterated per unit indicated at S2312 (S2316).

Furthermore, in order to perform the local adaptive frequency selective coding, a data array for the second sorting may be defined to be applied when the conditions of the FSC are true.

### Embodiment 3

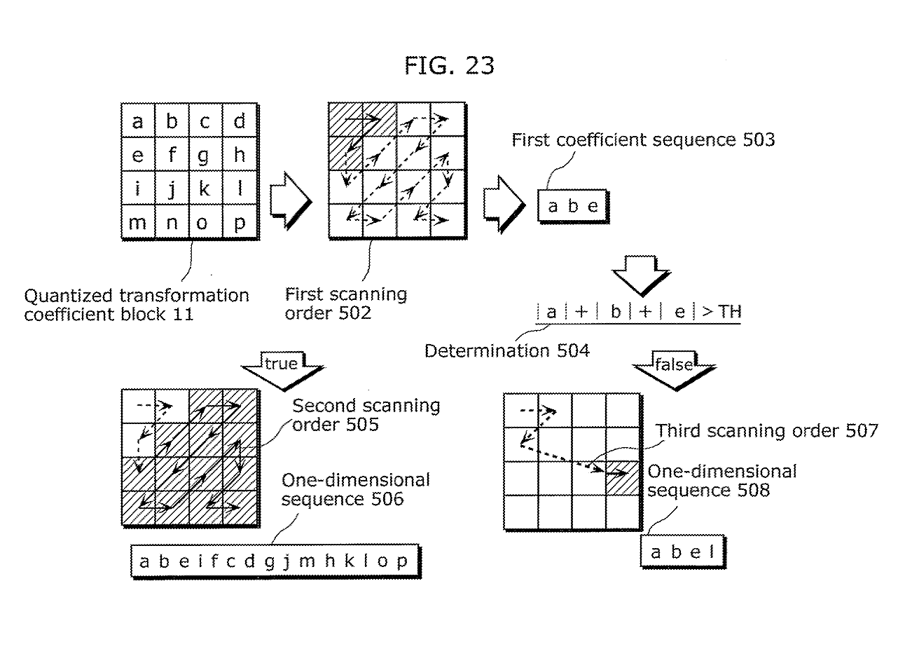

Next, Embodiment 3 in the present invention will be described with reference to FIG. 23. The sequence generating process and the matrix generating process according to Embodiment 2 are applied to the zig-zag scanning in Embodiment 3.

As described above, a coded amount of high-frequency coefficients is suppressed in FSC. However, since degradation is obvious without coding the high-frequency coefficients in an area (unit, such as block) where information about edges and others is large, desirably, the FSC is not performed in such an area. The system for notifying a decoding apparatus of the presence or absence of the FSC on a per-block basis is necessary. However, when information is given for each block, there is a problem that the overall amount of data to be coded considerably increases due to the large number of blocks. The apparatus and method for the local adaptive frequency selective coding according to Embodiment 3 determines the presence or absence of the FSC, based on information of the low-frequency coefficients to be coded, regardless of the presence or absence of the FSC.

The local adaptive frequency selective coding will be described with reference to FIG. 23. A two-dimensional quantization transformation coefficient block 11 is scanned in a first scanning order 502. After scanning to a predetermined position, the presence or absence of the FSC is determined. In FIG. 23, the determination is made after scanning to a position “e”.

In an area where degradation, such as edges, is easily recognized, a larger coefficient tends to be generated even in a low frequency range. Using the tendency, determination 504 of the FSC is made based on the coefficient in the low frequency range. The determination 504 may be made not based on the coefficient but based on the levels and signs, or whether the coefficient is a zero coefficient or a non-zero coefficient. Alternatively, the determination 504 may be made by weighting these information using a position, or based on a result of certain processing of function.

Here, a sum of absolute values of coefficients is compared to a predetermined threshold, based on a coefficient sequence obtained by scanning in the first scanning order 502, and on a first coefficient sequence 503. When the sum is larger than the threshold, the rest of the coefficients are scanned in a second scanning order 505. Thus, a one-dimensional sequence 506 as in FIG. 23 is obtained by combination with the first coefficient sequence 503. On the other hand, when the coefficients in the low frequency range are not large, the rest of the coefficients are scanned in a third scanning order 507. In this example, a coefficient only at the position of 1 is scanned. Thus, a one-dimensional sequence 508 is obtained by combination with the first coefficient sequence 503.

Although the first scanning order 502 is separate from the second scanning order 505 in the description, the first scanning order 502 and the second scanning order 505 are consecutive. The first scanning order 502 may be considered to be a part of a first half of the consecutive scanning orders. Furthermore, the consecutive scanning orders can be easily implemented as a general scanning order, such as the zig-zag scanning.

### Embodiment 4

Although the amount of data of a binary sequence indicating positions of non-zero coefficients is reduced in the example described in Embodiment 2, prevention of coding the subtree 1205 indicating the coefficient positions having no non-zero coefficient enables further reduction in the amount of data of a zero-tree structure and the amount of data of a binary sequence indicating valid nodes.

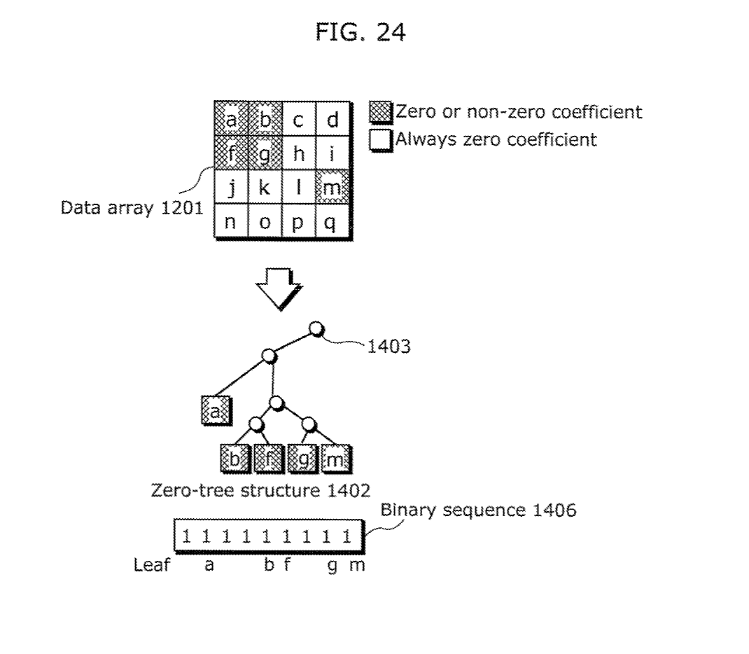

FIG. 24 illustrates the moving image coding method according to Embodiment 4. More specifically, FIG. 24 schematically illustrates determination of a zero-tree structure, and of a binary sequence indicating positions of non-zero coefficients.

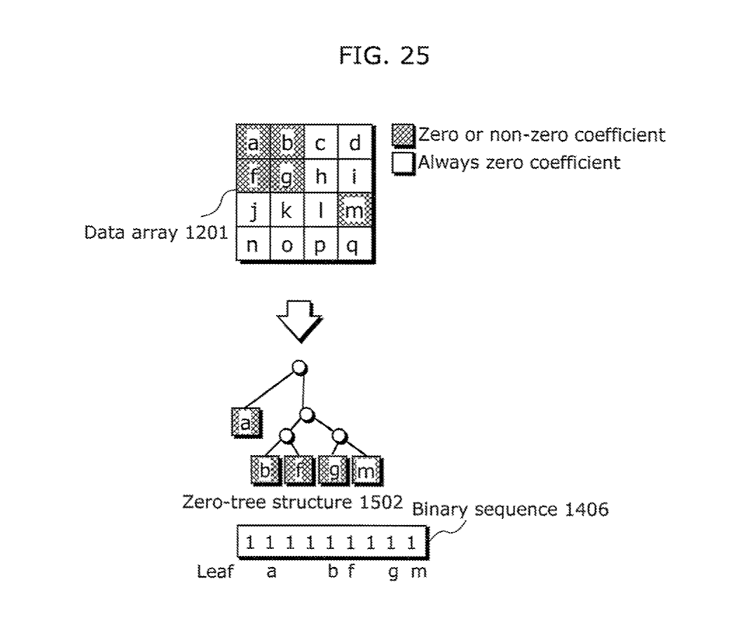

A zero-tree structure 1402 and a binary sequence 1406 indicating valid nodes are coded. Here, each of the zero-tree structure 1402 and the binary sequence indicates only coefficient positions possibly having non-zero coefficients. Although FIG. 24 illustrates an example in which all the possibly having non-zero coefficients indicate non-zero (all 1), there are cases where a part of the coefficients are zero. Furthermore, since a parent node 1403 in the zero-tree structure is redundant, the structure may be changed to a zero-tree structure 1502 in FIG. 25.

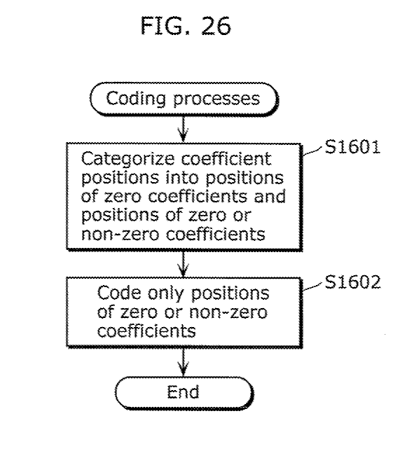

The moving image coding method according to Embodiment 4 determines the zero-tree structure as indicated in the flowchart in FIG. 26. First, coefficient positions are categorized into coefficient positions always having zero coefficients and coefficient positions possibly having non-zero coefficients (to be either zero coefficients or non-zero coefficients) (S1601). Then, only the coefficient positions possibly having non-zero coefficients are coded (S1602).

### Embodiment 5

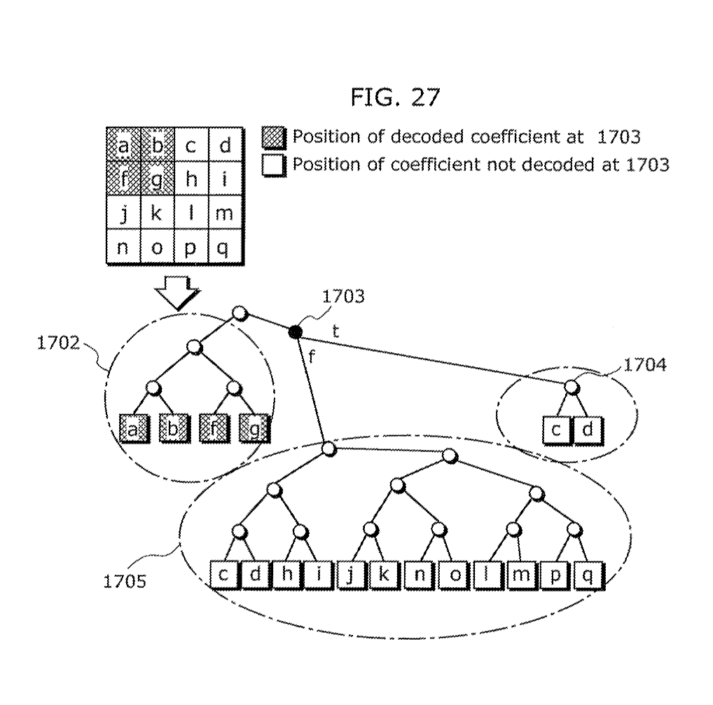

Embodiment 3 describes the local adaptive frequency selective coding (local adaptive FSC) when performing the zig-zag scanning. Embodiment 5 describes the local adaptive FSC when implementing the zero-tree structure. FIG. 27 schematically illustrates Embodiment 5. The subsequent portion of the zero-tree structure is switched to another according to a state of a subtree 1702 decoded and included in the zero-tree structure.

What is defined in the example of FIG. 27 is a conditional node 1703 that is a virtual node and indicates the time at which the switching determination is made. Reaching the conditional node 1703 in the process of searching (or traversing) the zero-tree structure, conditions of the local adaptive FSC are determined. Since the conditional node 1703 is virtual, elements that are included in the binary sequence indicating valid nodes and that are associated with the conditional node 1703 are not necessary. When a result of the determination of the conditional node is true, a portion 1704 in the zero-tree structure is selected. When a result of the determination of the conditional node is not true, a portion 1705 in the zero-tree structure is selected.

The state of the decoded subtree 1702 is defined based on information including a position of a coefficient included in the subtree 1702, the level and sign of the coefficient, and indicating whether the coefficient is a zero coefficient or a non-zero coefficient and whether the node has a valid value. Alternatively, the state of the decoded subtree 1702 may be defined by weighting these information using to coefficient positions, or based on a result of certain processing of function.

Furthermore, the state of the decoded subtree 1702 may be defined based on the position information item in a quantization parameter or a block in a frame, and on a type of a mode for generating a predictive image. The quantization parameter is a parameter used by a coding apparatus for controlling change in distribution of data to an area where degradation is visually recognizable and an area where degradation is not visually recognizable. According to the parameter, adaptively determining conditions results in control such that the degradation is not visually recognizable.

It is described that the time at which the local adaptive FSC is indicated by a virtual node, and elements indicating valid nodes in the binary sequence are not associated with each other. However, a structure in which the elements in the binary sequence indicating valid nodes are associated with each other may be considered as one of the conditions for determining the local adaptive FSC. Although the structure has an advantage that the coding apparatus can explicitly control determining the local adaptive FSC, there is a disadvantage of increased amount of data. Embodiment 5 assumes that the elements in the binary sequence are not associated with each other.

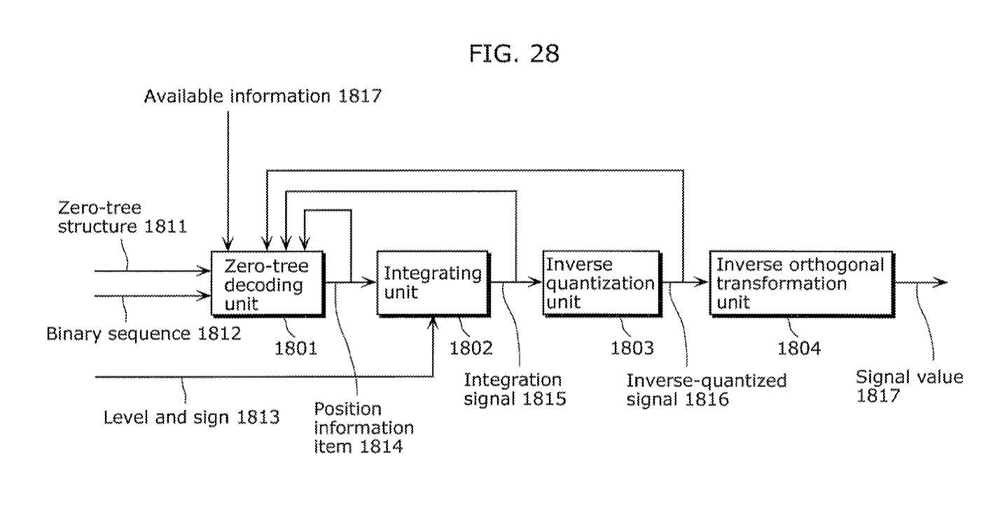

FIG. 28 illustrates a block diagram of a moving image decoding apparatus according to Embodiment 5. The decoding apparatus includes a zero-tree decoding unit 1801, an integrating unit 1802, an inverse quantization unit 1803, and an inverse orthogonal transformation unit 1804.

The zero-tree decoding unit 1801 receives a zero-tree structure 1811 and a binary sequence 1812 indicating valid nodes, and determines whether a node in the tree is valid or invalid. Then, the zero-tree decoding unit 1801 searches the tree until the next valid leaf node is found, and transmits a position information item 1814 of a (non-zero) coefficient associated with the searched leaf node. The position information item 1814 is transmitted to the integrating unit 1802

The integrating unit 1802 generates and transmits an integration signal 1815 by converting levels and signs 1813 that are separately received into the integration signal 1815 having the original arrangement (two-dimensional block or others), according to the position information item 1814. The integration signal 1815 is equivalent to the quantized coefficient in the coding apparatus.

The inverse quantization unit 1803 receives and inverse-quantizes the integration signal 1815, and transmits an inverse-quantized signal 1816. The inverse-quantized signal 1816 is equivalent to the orthogonal transformation coefficient in the coding apparatus. The inverse orthogonal transformation unit 1804 receives and inverse-orthogonal transforms the inverse-quantized signal 1816, and transmits a signal 1817.

The characteristic configuration of the decoding apparatus according to Embodiment 5 is to satisfy more than one of the following (i) to (iv): (i) the zero-tree decoding unit 1801 receives the past outputs of the zero-tree decoding unit 1801, and adaptively changes the position information item 1814 for output; (ii) the zero-tree decoding unit 1801 receives the past integration signal 1805, and adaptively changes the position information item 1814 for output; (iii) the zero-tree decoding unit 1801 receives the past inverse-quantized signal 1816, and adaptively changes the position information item 1814 for output; and (iv) the zero-tree decoding unit 1801 receives other available information (signal 1817) in the block, and adaptively changes the position information item 1814 for output. There are cases where in (i), the past outputs include a value of a node searched in a zero tree.

Furthermore, assuming that a partial zero-tree structure to be referenced as determination conditions of the FSC in the local adaptive FSC or a partial zero-tree structure corresponding to coefficients in a low frequency range is referred to as a first zero-tree structure, the coding apparatus according to Embodiment 5 determines the first zero-tree structure to be optimal according to the occurrence frequency of the coefficients belonging to the first zero-tree structure. Similarly, assuming that two partial zero-tree structures to be switched in the local adaptive FSC are referred to as second and third zero-tree structures, the coding apparatus according to Embodiment 5 determines the second zero-tree structure to be optimal according to the occurrence frequency of the coefficients belonging to the second zero-tree structure. Furthermore, the coding apparatus according to Embodiment 5 determines the third zero-tree structure to be optimal according to the occurrence frequency of the coefficients belonging to the third zero-tree structure.

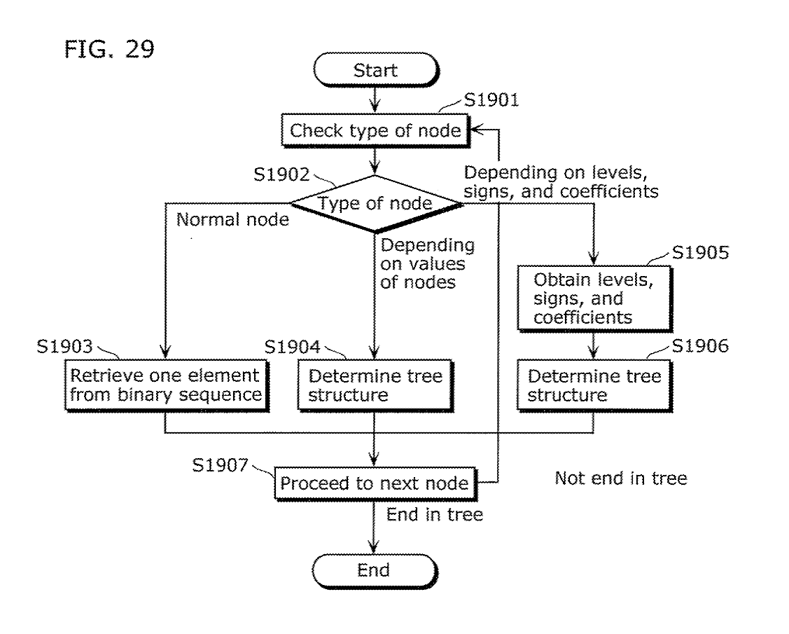

FIG. 29 is a flowchart for describing the local adaptive processes performed by the zero-tree decoding unit 1801 in the coding apparatus and the decoding apparatus according to Embodiment 5. Unlike the conventional configuration, there are cases where the zero-tree decoding unit 1801 includes conditional nodes in the process for searching a node.

First, a type of a node at a currently searched position is checked (S1901). Next, when the type of the node is a normal node without any conditions, one element is retrieved from a binary sequence indicating valid nodes (S1903), and proceeds to the next node (S1907).

When the type of the node is a conditional node of a type depending on values of past nodes, the conditions are determined. Then, the tree structure is determined in accordance with a method previously defined (notified from the coding apparatus) according to a result of the determination (S1904). The determination of the tree structure may include a partial change, and reorganization of the relationship between leaf nodes and coefficients.

After determining the tree structure, the processing proceeds to the next node (S1907). When the type of a node is a conditional node of a type depending on levels and signs of coefficients of past nodes, or on the coefficients, the necessary levels and the signs of the coefficients, or the coefficients are obtained (S1905).

Then, similar to the determination operation at S1904, the tree structure is determined based on the levels or the signs of the coefficients, or the coefficients (S1906). After determining the tree structure, the processing proceeds to the next node (S1907). When proceeding to the next node (S1907), in the case where the next node is not included in the tree structure, the processing ends.

### Embodiment 6

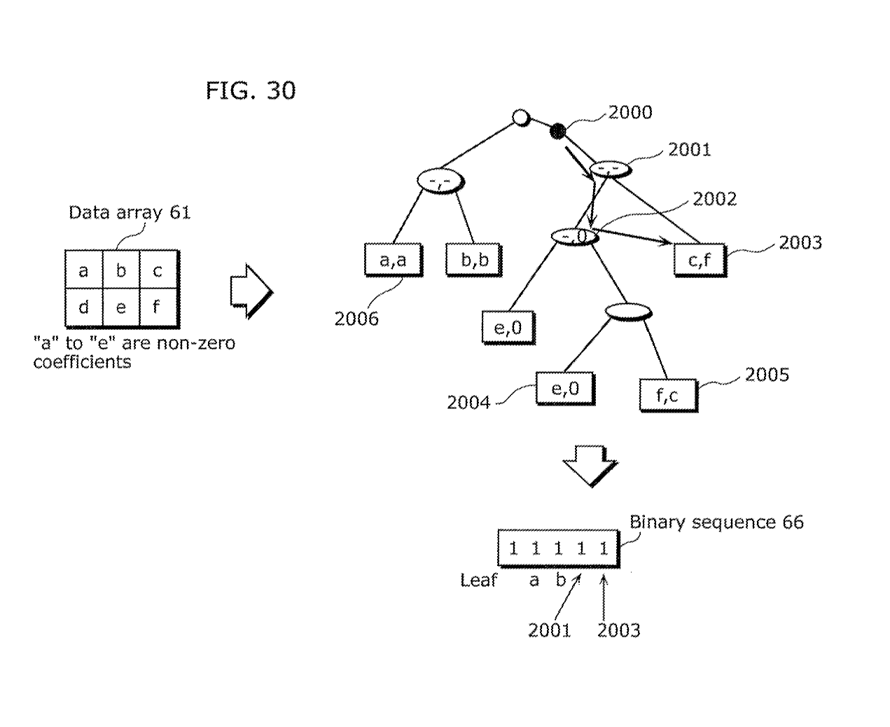

Embodiment 6 provides a data structure enabling holding of values at a node as a tree structure for changing a portion of a tree as by the local adaptive FSC, and a method of coding and decoding the data structure. FIG. 30 schematically illustrates partially changing the tree structure using nodes each having values.

The zero-tree structure according to Embodiment 6 has a structure in which each node has values, or at least two values. At the beginning of searching the zero-tree structure, the first value is to be referenced to. When it is determined that the FSC becomes true at a switching node 2000, the second value is to be referenced to in the processes after the switching node 2000. The defined two types of the second value include a fetch that is a value indicative of fetching elements from a binary sequence indicating valid nodes in the tree traversal, and a default that is a fixed value on a per-frame basis, on a per-slice basis, or on a per-blocks basis.

In FIG. 30, the fetch is indicated by “—” at an internal node, and by a letter of the alphabet corresponding to a coefficient position, at a leaf node. Invalidation of the node can be described with a predetermined input of 0 indicating a default as the second value, and coding of the zero coefficients can be skipped (corresponding to nodes 2002 and 2004 in FIG. 30).

Furthermore, there is an advantage of setting, to the second value, a coefficient position different from that of the first value as at the node 2003. As indicated in examples of coefficients “f” and “c” respectively at nodes 2005 and 2003, the number of nodes to be traversed until being searched can be changed. As such, it is highly likely that the amount of data of the binary sequence indicating valid nodes can be reduced by shifting the coefficient having higher occurrence frequency to a node in an earlier traversal order.

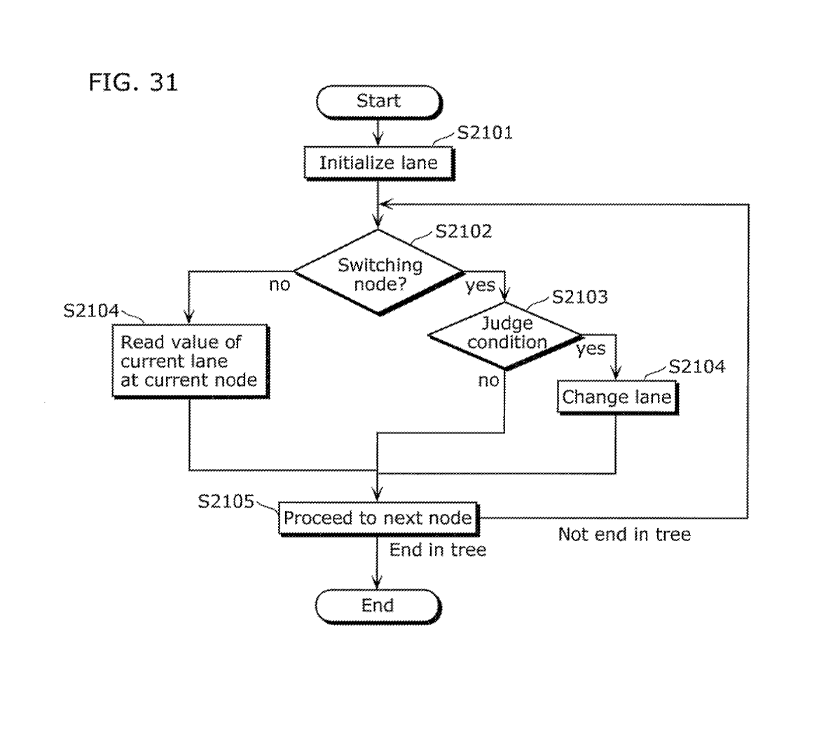

FIG. 31 is a flowchart for performing a tree structure decoding method according to Embodiment 6 in which a tree structure is searched while values at a node to be read are switched. Here, information indicating which value is to be read at a node is referred to as a lane.

First, a lane is initialized (S2101). Next, upon start of the search, a type of a node is examined. When the node is a switching node for determining conditions for the local adaptive FSC and others (Yes at S2102), the relevant condition is judged (S2103).

When a result of the judgment is true (Yes at S2103), operations, such as changing a relevant lane, are performed (S2104), and the process proceeds to the next node (S2105). On the other hand, when the result of the judgment is not true (No at S2103), the process proceeds to the next node (S2105) without changing the relevant lane.

When the node is not the switching node for determining the type of the node (No at S2102), the value of the current lane at the current node is read (S2104), normal operations for decoding a zero-tree structure are performed, and the process proceeds to the next node (S2105). When there are remaining nodes in proceeding to the next node (S2105), the process is back to determining of the type of the node at S2102. When there is no node, the process ends at S2105.

### Embodiment 7

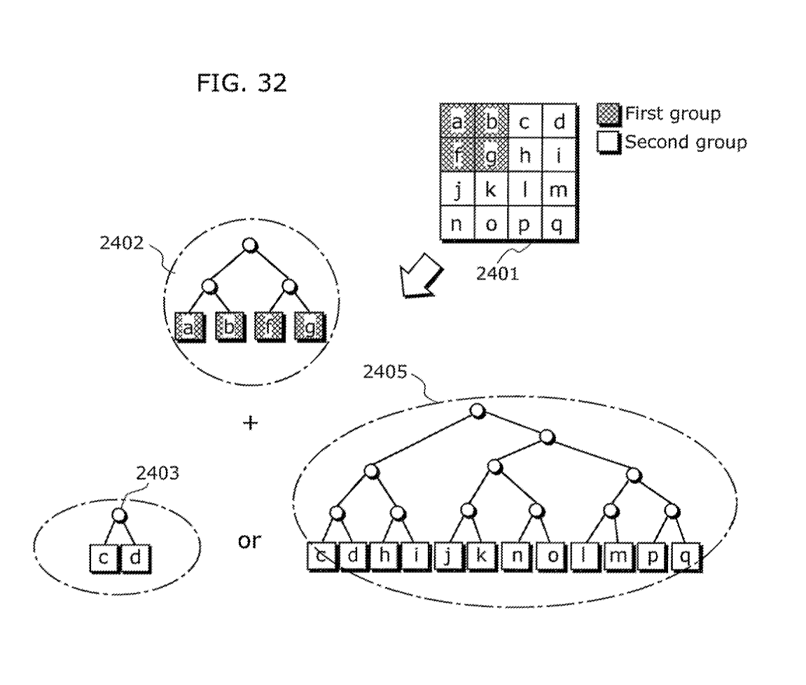

Although FIG. 27 illustrates the configuration using a virtual node, there are cases where a larger tree causes the inconvenience in management as a whole. As illustrated in FIG. 32, a quantized two-dimensional transformation coefficient block 2401 is grouped into a first group of quantized coefficients and a second group of quantized coefficients.

A partial zero-tree structure 2402 is defined from the first group. A partial zero-tree structure 2403 or partial zero-tree structures 2405 are defined for the second group. Out of the second group, the partial zero-tree structure 2403 is selected or the partial zero-tree structures 2405 are selected based on the coefficients, the levels, and the signs or the binary sequence indicating valid nodes obtained after searching (or traversing) the partial zero-tree structure 2402 of the first group.

Since the structure is separately defined from the tree with conditional-branching virtual nodes, there is an advantage that the unit that decodes the tree structure does not conventionally have to be changed. Although two sets of the partial zero-tree structure 2403 and the partial zero-tree structures 2405 for the second group are illustrated in FIG. 32, there may be not smaller than three partial zero-tree structures. Furthermore, although the quantized coefficient group is divided into the first group of quantized coefficients and the second group of quantized coefficients in FIG. 32, it may be divided into not smaller than three groups of quantized coefficients.

In any one of the conventional and dominant zig-zag scanning and the zero-tree traversal, a coding apparatus (i) divides the quantized coefficients into a binary sequence indicating non-zero coefficients (or binary sequence indicating valid nodes) and a non-zero coefficient sequence, and (ii) further divides the non-zero coefficients into levels and signs. According to Embodiment 7, the quantized coefficients need to be divided into not smaller than two groups, and each of the binary sequence and the non-zero sequence (including level or sign) needs to be divided into two groups.

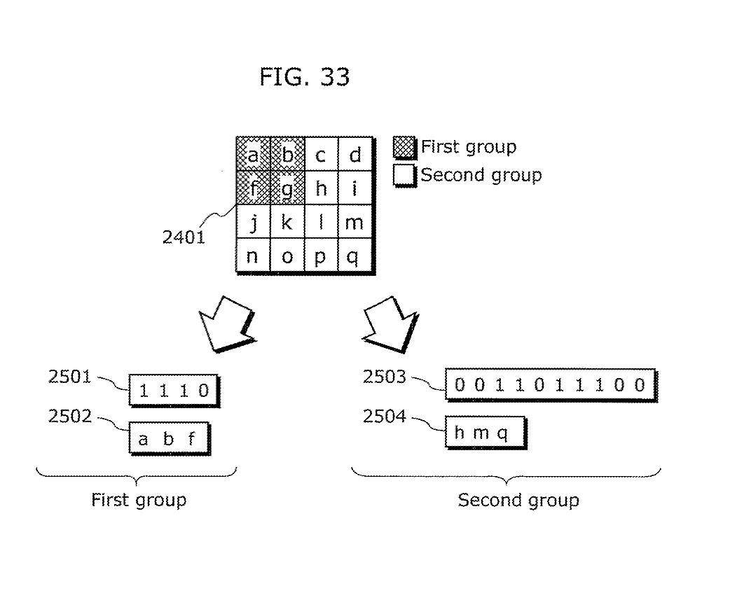

FIG. 33 illustrates data arrays of binary sequences and non-zero coefficient sequences. A binary sequence 2501 of valid nodes in the first group, a non-zero coefficient sequence 2502 in the first group, a binary sequence 2503 of valid nodes in the second group, and a non-zero coefficient sequence 2504 in the second group are sequentially arranged. The non-zero coefficient sequence 2502 in the first group is arranged in this order because it needs non-zero coefficients for determining a partial zero-tree structure of the second group.

On the other hand, when the non-zero coefficients are not used for determining the part of the zero-tree structure of the second group (using only the binary sequence 2501 of the valid nodes in the first group, a quantization parameter of the block, or others), the binary sequence 2501 of the valid nodes in the first group, the binary sequence 2503 of the valid nodes in the second group, the non-zero coefficient sequence 2502 in the first group, and the non-zero coefficient sequence 2504 in the second group may be sequentially arranged. Furthermore, two of the non-zero coefficient sequences 2502 and 2504 may not be divided.

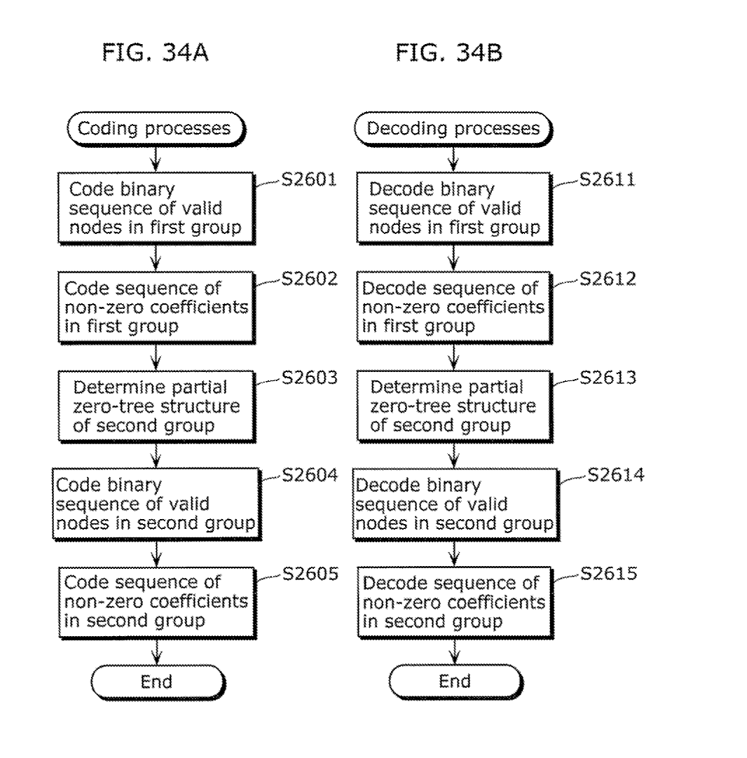

FIG. 34A is a flowchart indicating the operating procedure in each block of the moving image coding apparatus according to Embodiment 7. A partial zero-tree structure of the first group and a partial zero-tree structure of the second group are coded in advance on a per-frame basis, on a per-slice basis, or on a per-blocks basis. The binary sequence of the valid nodes in the first group is coded in each block (S2601). Next, a sequence of non-zero coefficients in the first group is coded (S2602). Next, a partial zero-tree structure of the second group is determined (S2603). After the determination, the binary sequence of the valid nodes in the second group is coded (S2604). Then, a sequence of non-zero coefficients in the second group is coded (S2605).

FIG. 34B is a flowchart indicating the operating procedure in each block of the moving image decoding apparatus according to Embodiment 7. The operations corresponds to the decoding apparatus. A partial zero-tree structure of the first group and a part of the zero-tree structure of the second group are decoded in advance on a per-frame basis, on a per-slice basis, or on a per-blocks basis. The binary sequence of the valid nodes in the first group is decoded in each block (S2611). Next, the sequence of non-zero coefficients in the first group is decoded (S2612). Next, the partial zero-tree structure of the second group is determined (S2613). After the determination, the binary sequence of the valid nodes in the second group is decoded (S2614). Then, the sequence of non-zero coefficients in the second group is decoded (S2615).

Assumed here is that the coding apparatus explicitly notifies the decoding apparatus of the partial zero tree of the second group on a per-frame basis or others. However, since the number of elements of a group is reduced due to the division of coefficients into groups, the conventional zig-zag scanning may reduce the processing amount without using the zero-tree traversal. In particular, when the first group is in a narrow area (2×2) in a low frequency range, the zig-zag scanning is assumed to be simpler.

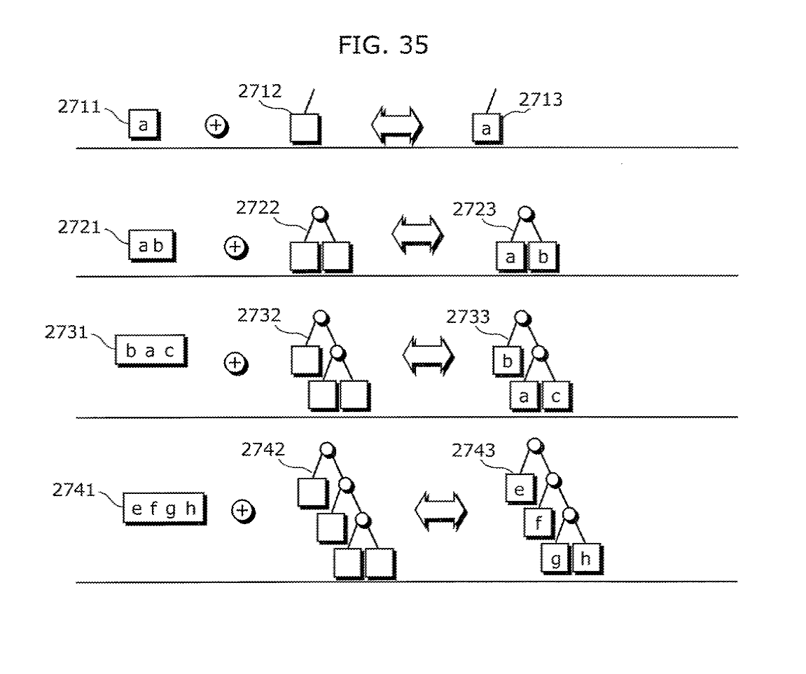

Furthermore, when the frequency selective coding is used, since the number of coefficients in a high frequency range is less, it is much simpler to directly notify the sequence of the coefficient positions without using the zero-tree structure, and limit the zero-tree structure such that it has no branch. FIG. 35 schematically illustrates the example.

As illustrated in FIG. 35, zero-tree structures 2712, 2722, 2732, and 2742 each having no information indicating a coefficient position are pre-defined to correspond to the number of coefficient positions. Then, combining coefficient positions 2711, 2721, 2731, and 2741 with the zero-tree structures 2712, 2722, 2732, and 2742 result in zero-tree structures 2713, 2723, 2733, and 2743, respectively.

The amount of data of the zero-tree structures 2712, 2722, 2732, and 2742 each having no information indicating a coefficient position can be reduced by suppressing the transmission frequency, such as transmitting only the first frame to be coded out of frames or transmitting each set of frames. Since the zero-tree structure having no information indicating a coefficient position does not vary over frames and only the coefficient position is updated in many applications, such as in the frequency selective coding, the advantage can be expected.

### Embodiment 8

Embodiment 8 provides a method of coding and decoding a partial zero-tree structure of the second group with less amount of data, as a modification example of Embodiment 7 that groups the quantized two-dimensional transformation coefficient block 2401 into the first group of quantized coefficients and the second group of quantized coefficients.

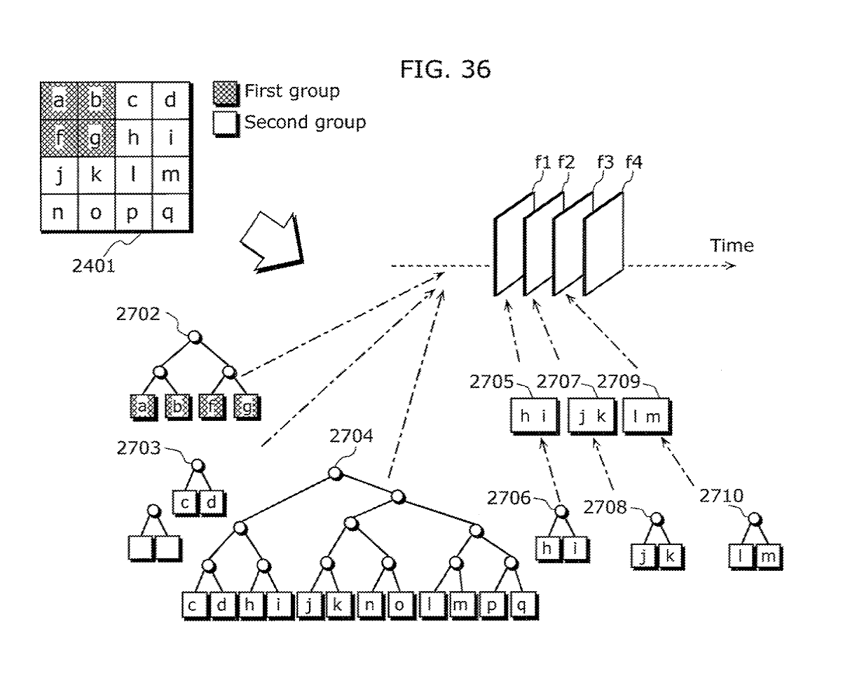

Although the coefficient position to be coded in the second group is updated on a per-frame basis (or on a per-slice basis, or on a per-blocks basis) in the local adaptive FSC, the number of coefficients are fixed, and only the coefficient positions are changed. Thus, when the partial zero-tree structure of the second group can be updated, the amount of data necessary for updating can be minimized. Furthermore, as illustrated in FIG. 35, by pre-defining the zero-tree structure having no information indicating a coefficient position, only the sequence of the coefficient positions to be coded has to be coded in each frame. FIG. 36 schematically illustrates the case.

A partial zero-tree structure 2702 of the first group is coded on a per-frames basis, and a second partial zero-tree structure 2703 that is included in the partial zero-tree structure of the second group and that is selected when the FSC is determined to be true in the block is coded, and a remaining partial zero-tree structure 2704 of the second group is further coded.

The second partial zero-tree structure 2703 selected when the FSC is determined to be true may hold information indicating coefficient positions as illustrated in FIG. 36, or may be a zero-tree structure each having no information indicating a coefficient position. In any of the cases, overwriting (or combining) the second partial zero-tree structure 2703 when the FSC is determined to be true, with a sequence of the coefficient positions to be coded on a per-frame basis results in the second partial zero-tree structure when the FSC is determined to be true.

At a frame f1, a coefficient position sequence 2705 is combined with the second partial zero-tree structure 2703, thus resulting in a second partial zero-tree structure 2706 when the FSC is determined to be true at the frame f1. Similarly at a frame f2, a coefficient position sequence 2707 is combined with the second partial zero-tree structure 2703, thus resulting in a second partial zero-tree structure 2708 when the FSC is determined to be true at the frame f2.

### Embodiment 9

The processing described in Embodiments 1 to 8 can be simply implemented by recording, in a recording medium, a program for implementing the configuration for the image coding method or the image decoding method described in Embodiments 1 to 8. The recording medium may be any recording medium as long as the program can be recorded thereon, such as a magnetic disk, an optical disc, a magnetic optical disk, an IC card, and a semiconductor memory.

Hereinafter, the applications to the image coding method and the image decoding method described in Embodiments 1 to 8 and a system using the same will be described.

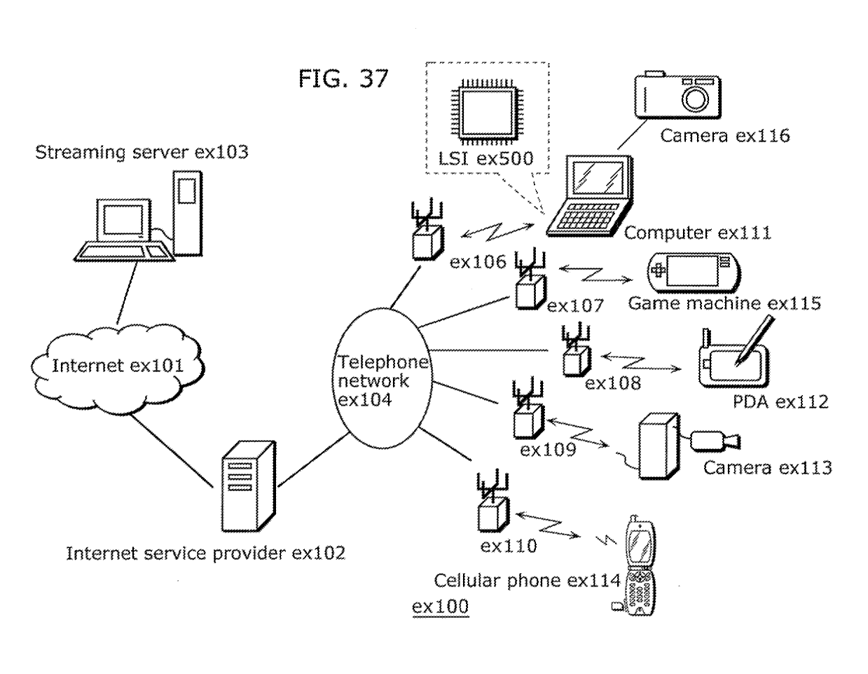

FIG. 37 illustrates an overall configuration of a content providing system ex102 for implementing content distribution services. The area for providing communication services is divided into cells of desired size, and base stations ex102 to ex102 which are fixed wireless stations are placed in each of the cells.

The content providing system ex102 is connected to devices, such as a computer ex111, a personal digital assistant (PDA) ex112, a camera ex113, a cellular phone ex114 and a game machine ex115, via an Internet ex101, an Internet service provider ex102, a telephone network ex104, as well as the base stations ex102 to ex102.

However, the configuration of the content providing system ex102 is not limited to the configuration shown in FIG. 37, and a combination in which any of the elements are connected is acceptable. In addition, each of the devices may be directly connected to the telephone network ex104, rather than via the base stations ex102 to ex102 which are the fixed wireless stations. Furthermore, the devices may be interconnected to each other via a short distance wireless communication and others.

The camera ex113, such as a digital video camera, is capable of capturing moving images. A camera ex116, such as a digital video camera, is capable of capturing both still images and moving images. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex102, a streaming server ex103 is connected to the camera ex113 and others via the telephone network ex104 and the base station ex109, which enables distribution of a live show and others. For such a distribution, a content (for example, video of a music live show) captured by the user using the camera ex113 is coded as described above in Embodiments 1 to 8, and the coded content is transmitted to the streaming server ex103. On the other hand, the streaming server ex103 carries out stream distribution of the received content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and/or moving images captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by a Large Scale Integration (LSI) ex500 generally included in each of the computer ex111 and the devices. The LSI ex500 may be configured of a single chip or a plurality of chips. Software for coding and decoding images may be integrated into some type of a recording medium (such as a CD-ROM, a flexible disk, a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers or computers, and may decentralize data and process the decentralized data, record, or distribute data.

As described above, the clients can receive and reproduce the coded data in the content providing system ex102. In other words, the clients can receive and decode information transmitted by the user, and reproduce the decoded data in real time in the content providing system ex102, so that the user who does not have any particular right and equipment can implement personal broadcasting.

Each of the devices included in the content providing system ex102 may perform coding and decoding respectively using the image coding method or the image decoding method described in each of Embodiments 1 to 8.

The cellular phone ex114 will be described as an example of such a device.

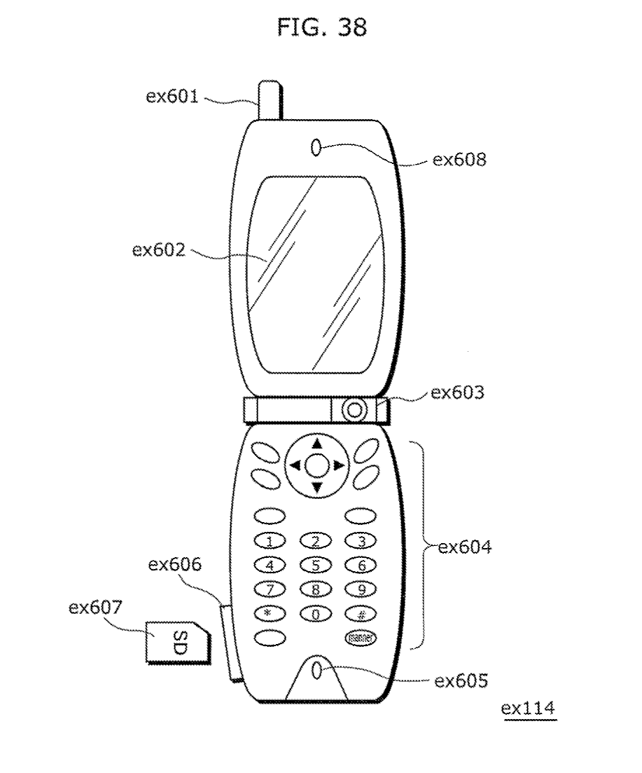

FIG. 38 illustrates the cellular phone ex114 that uses the image coding method and the image decoding method described in Embodiments 1 to 8. The cellular phone ex114 includes: an antenna ex601 for transmitting and receiving radio waves through the base station ex102; a camera unit ex603 such as a CCD camera capable of capturing moving and still images; a display unit ex602 such as a liquid crystal display for displaying the data such as decoded video captured by the camera unit ex603 or received by the antenna ex601; a main body unit including a set of operation keys ex604; an audio output, unit ex608 such as a speaker for output of audio; an audio input unit ex605 such as a microphone for input of audio; a recording medium ex607 for recording coded or decoded data including data of captured moving or still images, data of received e-mails, and data of moving or still images; and a slot unit ex606 for enabling the cellular phone ex114 to attach the recording medium ex607. The recording medium ex607 is a medium that stores a flash memory device within a plastic case, for example, an SD Card. The flash memory device is one type of Electrically Erasable and Programmable Read-Only Memory (EEPROM) which is a non-volatile memory that is electrically rewritable and erasable.

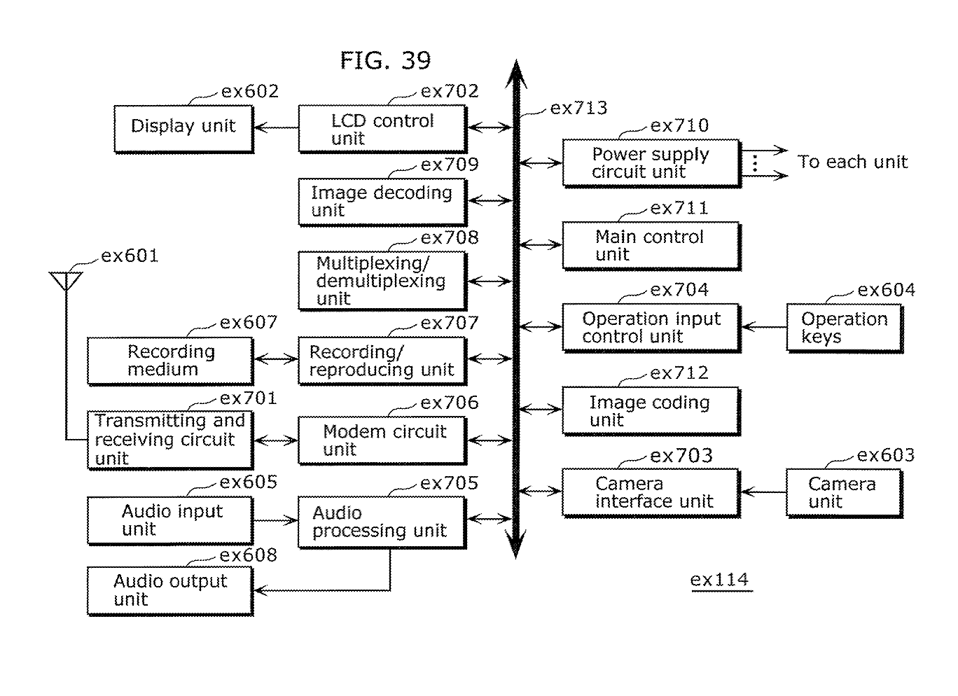

Next, the cellular phone ex114 will be described with reference to FIG. 39. In the cellular phone ex114, a main control unit ex711 designed to control overall each unit of the main body including the display unit ex602 as well as the operation keys ex604 is connected mutually, via a synchronous bus ex713, to a power supply circuit unit ex710, an operation input control unit ex704, an image coding unit ex712, a camera interface unit ex703, a liquid crystal display (LCD) control unit ex702, an image decoding unit ex709, a multiplexing/demultiplexing unit ex708, a recording/reproducing unit ex707, a modem circuit unit ex706, and an audio processing unit ex705.

When a call-end key or a power key is turned ON by a user's operation, the power supply circuit unit ex710 supplies the respective units with power from a battery pack so as to activate the cell phone ex114 that is digital and is equipped with the camera.

In the cellular phone ex114, the audio processing unit ex705 converts the audio signals collected by the audio input unit ex605 in voice conversation mode into digital audio data under the control of the main control unit ex711 including a CPU, ROM, and RAM. Then, the modem circuit unit ex706 performs spread spectrum processing on the digital audio data, and the transmitting and receiving circuit unit ex701 performs digital-to-analog conversion and frequency conversion on the data, so as to transmit the resulting data via the antenna ex601. In addition, in the cellular phone ex114, the transmitting and receiving circuit unit ex701 amplifies the data received by the antenna ex601 in voice conversation mode and performs frequency conversion and the analog-to-digital conversion on the data. Then, the modem circuit unit ex706 performs inverse spread spectrum processing on the data, and the audio processing unit ex705 converts it into analog audio data, so as to output it via the audio output unit ex608.

Furthermore, when an e-mail in data communication mode is transmitted, text data of the e-mail inputted by operating the operation keys ex604 of the main body is sent out to the main control unit ex711 via the operation input control unit ex704. The main control unit ex711 causes the modem circuit unit ex706 to perform spread spectrum processing on the text data, and the transmitting and receiving circuit unit ex701 performs the digital-to-analog conversion and the frequency conversion on the resulting data to transmit the data to the base station ex102 via the antenna ex601.

When image data is transmitted in data communication mode, the image data captured by the camera unit ex603 is supplied to the image coding unit ex712 via the camera interface unit ex703. Furthermore, when the image data is not transmitted, the image data captured by the camera unit ex603 can be displayed directly on the display unit ex602 via the camera interface unit ex703 and the LCD control unit ex702.

The image coding unit ex712 including the image coding apparatus as described for the present invention compresses and codes the image data supplied from the camera unit ex603 using the coding method employed by the image coding apparatus as shown in Embodiments 1 to 8 so as to transform the data into coded image data, and sends the data out to the multiplexing/demultiplexing unit ex708. Furthermore, the cellular phone ex114 simultaneously sends out, as digital audio data, the audio collected by the audio input unit ex605 during the capturing with the camera unit ex603 to the multiplexing/demultiplexing unit ex708 via the audio processing unit ex705.

The multiplexing/demultiplexing unit ex708 multiplexes the coded image data supplied from the image coding unit ex712 and the audio data supplied from the audio processing unit ex705, using a predetermined method. Then, the modem circuit unit ex706 performs spread spectrum processing on the multiplexed data obtained by the multiplexing/demultiplexing unit ex708. After the digital-to-analog conversion and frequency conversion on the data, the transmitting and receiving circuit unit ex701 transmits the resulting data via the antenna ex601.

When receiving data of a video file which is linked to a Web page and others in data communication mode, the modem circuit unit ex706 performs inverse spread spectrum processing on the data received from the base station ex102 via the antenna ex601, and sends out the multiplexed data obtained as a result of the inverse spread spectrum processing to the multiplexing/demultiplexing unit ex708.

In order to decode the multiplexed data received via the antenna ex601, the multiplexing/demultiplexing unit ex708 demultiplexes the multiplexed data into a bit stream of image data and that of audio data, and supplies the coded image data to the image decoding unit ex709 and the audio data to the audio processing unit ex705, respectively via the synchronous bus ex713.

Next, the image decoding unit ex709 including the image decoding apparatus described according to the present invention decodes the bit stream of the image data using a decoding method corresponding to the coding method as described in Embodiments 1 to 8 so as to generate reproduced video data, and supplies this data to the display unit ex602 via the LCD control unit ex702. Thus, the video data included in the video file linked to the Web page, for instance, is displayed. Simultaneously, the audio processing unit ex705 converts the audio data into analog audio data, and supplies the data to the audio output unit ex608. Thus, the audio data included in the video file linked to the Web page, for instance, is reproduced.

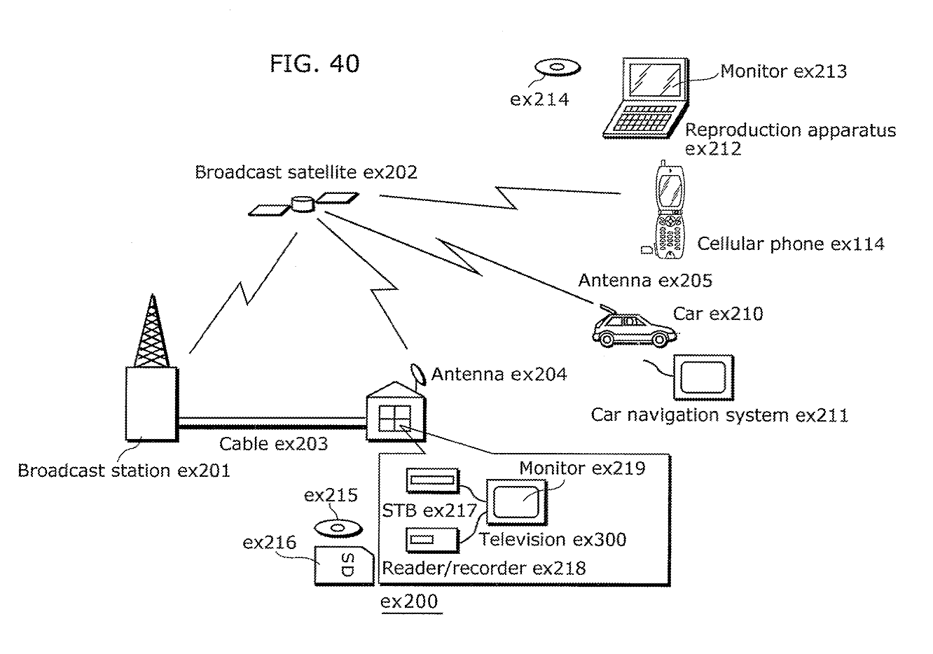

The present invention is not limited to the above-mentioned system because terrestrial or satellite digital broadcasting has been in the news lately, and at least the image coding apparatus described in Embodiment 1 can be incorporated into a digital broadcasting system as shown in FIG. 40. More specifically, a broadcast station ex201 communicates or transmits, via radio waves to a broadcast satellite ex202, audio data, video data, or a bit stream obtained by multiplexing the audio data and the video data. Upon receipt of the bit stream, the broadcast satellite ex202 transmits radio waves for broadcasting. Then, a home-use antenna ex204 with a satellite broadcast reception function receives the radio waves, and a device, such as a television (receiver) ex300 and a set top box (STB) ex217 decodes a coded bit stream and reproduces the decoded bit stream. Furthermore, a reader/recorder ex218 that reads and decodes such a bit stream obtained by multiplexing image data and audio data that are recorded on recording media ex215 and 216, such as a CD and a DVD may include an image decoding apparatus described in Embodiments 1 to 8. In this case, the reproduced video signals are displayed on the monitor ex219. It is also possible to implement the image decoding apparatus in the set top box ex217 connected to a cable ex203 for a cable television or an antenna ex204 for satellite and/or terrestrial broadcasting, so as to reproduce the video signals on the monitor ex219 of the television ex300. The image decoding apparatus may be included not in the set top box but in the television ex300. Also, a car ex210 having an antenna ex205 can receive signals from the satellite ex202 or the base station ex201 for reproducing video on a display device such as a car navigation system ex211 set in the car ex210.

Furthermore, the image coding apparatus or the image coding apparatus as shown in Embodiments 1 to 8 can be implemented in the reader/recorder ex218 (i) for reading and decoding the video data, the audio data, or the coded bit stream obtained by multiplexing the video data and the audio data, or (ii) for coding the video data, the audio data, or the coded bit stream obtained by multiplexing the video data and the audio data and recording the resulting data as the multiplexed data on the recording medium ex215. Here, the video data and the audio data are recorded on the recording medium ex215, such as a BD and a DVD. In this case, the reproduced video signals are displayed on the monitor ex219. Furthermore, the reproduced video signals can be reproduced by another device or system, using the recording medium ex215 on which the coded bit stream is recorded. For example, another reproduction apparatus ex212 can reproduce the video signals on a monitor ex213, using a recording medium ex214 on which the coded bit stream is copied.

Furthermore, it is also possible to implement the image decoding apparatus in the set top box ex217 connected to the cable ex203 for a cable television or the antenna ex204 for satellite and/or terrestrial broadcasting, so as to display the video signals on the monitor ex219 of the television ex300. The image decoding apparatus may be included not in the set top box but in the television ex300.

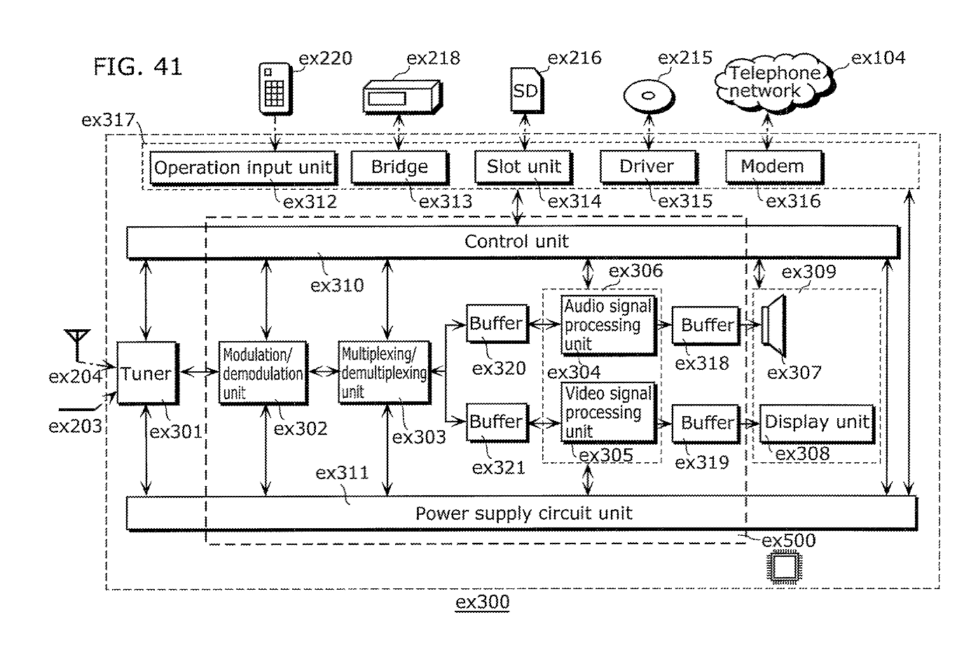

FIG. 41 illustrates the television (receiver) ex300 that uses the image decoding method and the image coding method described in Embodiments 1 to 8. The television ex300 includes: a tuner ex301 that obtains or provides a bit stream of video information through the antenna ex204 or the cable ex203, etc. that receives a broadcast; a modulation/demodulation unit ex302 that demodulates the received coded data or modulates data into coded data to be supplied outside; and a multiplexing/demultiplexing unit ex303 that demultiplexes the modulated data into video data and audio data, or multiplexes the coded video data and audio data into data. Furthermore, the television ex300 further includes: a signal processing unit ex306 including an audio signal processing unit ex304 and a video signal processing unit ex305 that decode audio data and video data and code audio data and video data, respectively; a speaker ex307 that provides the decoded audio signal; and an output unit ex309 including a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to one another through a synchronous bus.

First, a configuration in which the television ex300 decodes data obtained from outside through the antenna ex204 and others and reproduces the decoded data will be described. In the television ex300, upon receipt of a user operation from a remote controller ex220 and others, the multiplexing/demultiplexing unit ex303 demultiplexes the video data and audio data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in Embodiments 1 to 8, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read a coded bitstream not through a broadcast and others but from the recording media ex215 and ex216, such as a magnetic disk, an optical disc, and a SD card. Next, a configuration in which the television ex300 codes an audio signal and a video signal, and transmits the data outside or writes the data on a recording medium will be described. In the television ex300, upon receipt of a user operation from the remote controller ex220 and others, the audio signal processing unit ex304 codes an audio signal, and the video signal processing unit ex305 codes a video signal, under control of the control unit ex310 using the coding method as described in Embodiments 1 to 8. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in buffers ex320 and ex321, and others so that the signals are reproduced in synchronization with each other. Here, the buffers ex318 to ex321 may be plural as illustrated, or at least one buffer may be shared in the television ex300. Furthermore, data may be stored in a buffer other than the buffers ex318 to ex321 so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may not be capable of coding, multiplexing, and providing outside data but capable of only one of receiving, decoding, and providing outside data.

Furthermore, when the reader/recorder ex218 reads or writes a coded bit stream from or in a recording medium, one of the television ex300 and the reader/recorder ex218 may decode or code the coded bit stream, and the television ex300 and the reader/recorder ex218 may share the decoding or coding.

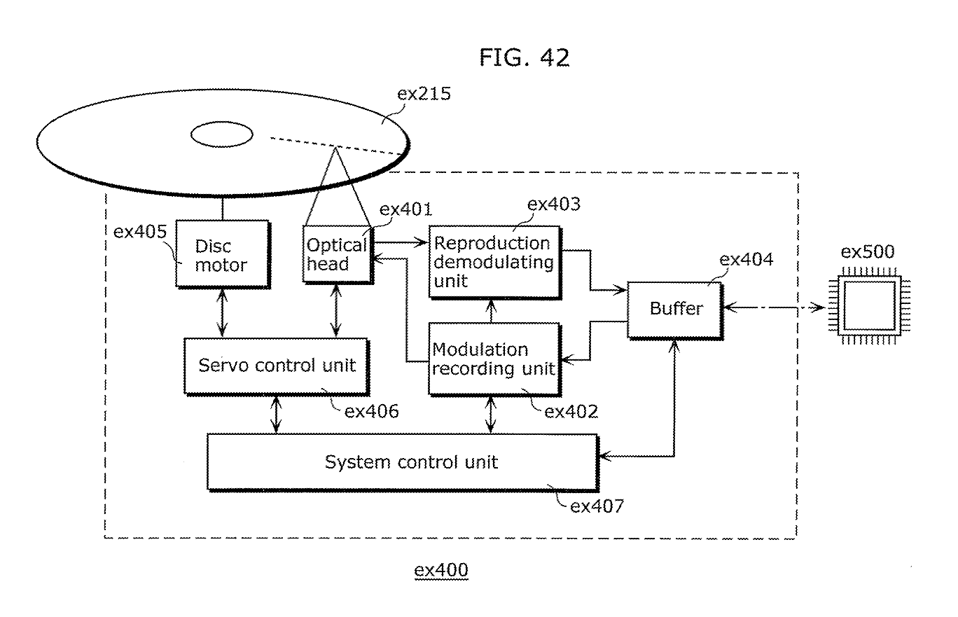

As an example, FIG. 42 illustrates a configuration of an information reproducing/recording unit ex400 when data is read or written from or in an optical disc. The information reproducing/recording unit ex400 includes constituent elements ex401 to ex407 to be described hereinafter. The optical head ex401 irradiates a laser spot on a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. A disc motor ex405 rotates the recording medium ex215. A servo control unit ex406 moves the optical head ex401 to a predetermined information track while controlling the rotation drive of the disc motor ex405 so as to follow the laser spot. The system control unit ex407 controls overall the information reproducing/recording unit ex400. The reading and writing processes can be implemented by the system control unit ex407 using various information held in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

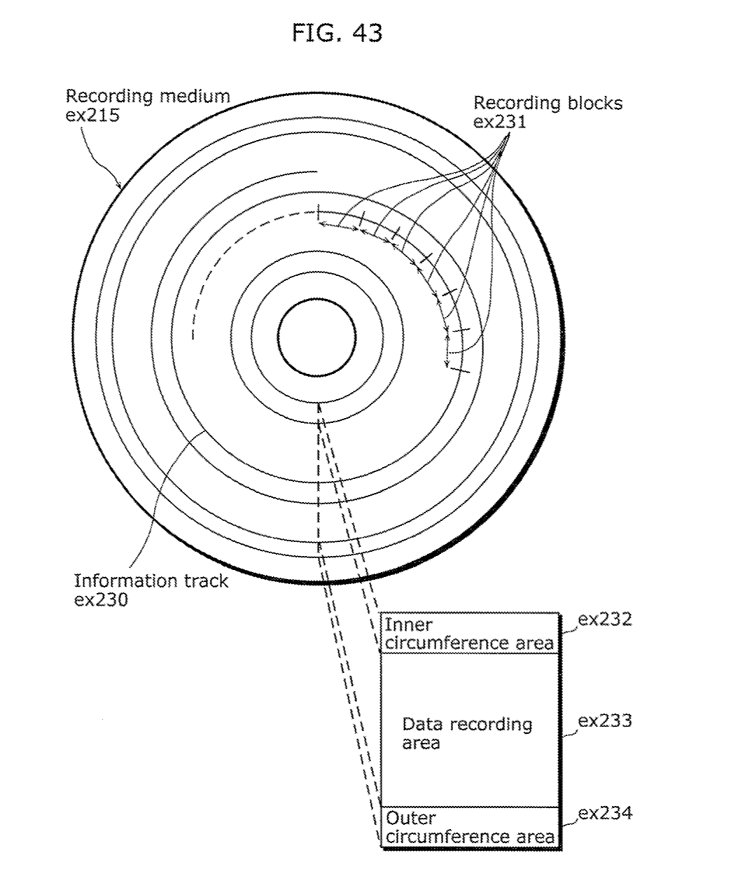

FIG. 43 schematically illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. An apparatus that records and reproduces data reproduces the information track ex230 and reads the address information so as to determine the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio data, coded video data, or coded data obtained by multiplexing the coded audio data and the coded video data, from and in the data recording area ex233 of the recording medium ex215.

Although an optical disc having a layer, such as a DVD and a BD is described as an example in the description, the optical disk is not limited to such, and may be an optical disk having a multilayer structure and capable of being recorded on a part other than the surface. Furthermore, the optical disc may have a structure for multidimensional recording/reproduction, such as recording information using light of colors with different wavelengths in the same portion of the optical disc and recording information having different layers from various angles.

Furthermore, the car ex210 having the antenna ex205 can receive data from the satellite ex202 and others, and reproduce video on the display device such as the car navigation system ex211 set in the car ex210, in a digital broadcasting system ex200. Here, a configuration of the car navigation system ex211 will be a configuration, for example, including a GPS receiving unit from the configuration illustrated in FIG. 41. The same will be true for the configuration of the computer ex111, the cellular phone ex114, and others. Furthermore, similarly to the television ex300, a terminal such as the cellular phone ex114 may have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus.

As such, the image coding method or the image decoding method in Embodiments 1 to 8 can be used in any of the devices and systems described. Thus, the advantages described in Embodiments 1 to 8 can be obtained.

Furthermore, the present invention is not limited to Embodiments 1 to 8, and various modifications and revisions are possible without departing from the scope of the present invention.

### Embodiment 10

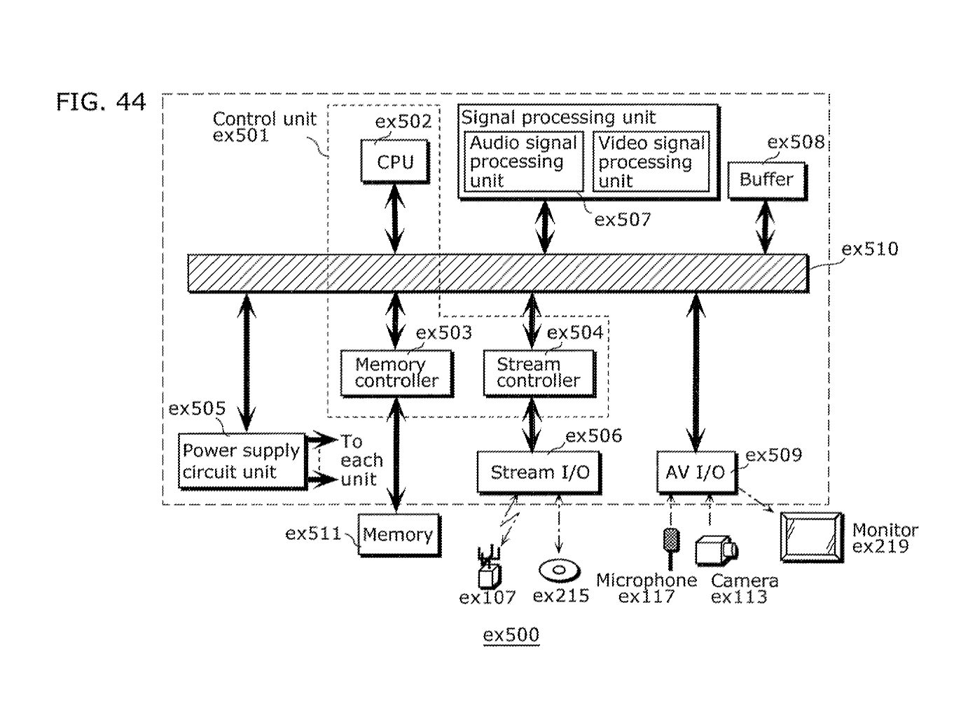

Each of the image coding method and apparatus and the image decoding method and apparatus in Embodiments 1 to 9 is typically achieved in the form of an integrated circuit or a LSI circuit. As an example, FIG. 44 illustrates a configuration of an LSI ex500 that is made into one chip. The LSI ex500 includes elements ex501 to ex509 to be described below, and the elements are connected to each other through a bus ex510. The power supply circuit unit ex505 is activated by supplying each of the elements with power when power is on.

For example, when coding is performed, the LSI ex500 receives an AV signal from a microphone ex117, a camera ex113, and others through an AV IO ex509 under control of a control unit ex501 including a CPU ex502, a memory controller ex503, and a stream controller ex504. The received AV signal is temporarily stored in a memory ex511 outside the LSI ex500, such as an SDRAM. Under control of the control unit ex501, the stored data is subdivided into data portions according to the processing amount and speed as necessary. Then, the data portions are transmitted to a signal processing unit ex507. The signal processing unit ex507 codes an audio signal and/or a video signal. Here, the coding of the video signal is the coding described in Embodiments 1 to 9. Furthermore, the signal processing unit ex507 sometimes multiplexes the coded audio data and the coded video data, and a stream I/O ex506 provides the multiplexed data outside. The provided bit stream is transmitted to a base station ex107, or written into the recording medium ex215. When data sets are multiplexed, the data sets should be temporarily stored in the buffer ex508 so that the data sets are synchronized with each other.

For example, when coded data is decoded, the LSI ex500 temporarily stores, in the memory ex511, the coded data obtained from the base station ex107 through the stream I/O ex506 or read from the recording medium ex215 under control of the control unit ex501. Under control of the control unit ex501, the stored data is subdivided into data portions according to the processing amount and speed as necessary. Then, the data portions are transmitted to the signal processing unit ex507. The signal processing unit ex507 decodes audio data and/or video data. Here, the coding of the video signal is the coding described in Embodiments 1 to 9. Furthermore, a decoded audio signal and a decoded video signal may be temporarily stored in the buffer ex508 and others so that the signals can be reproduced in synchronization with each other. Each of the output units, such as the cellular phone ex114, the game machine ex115, and the television ex300 provides the decoded output signal through, for example, the memory 511 as necessary.

Although the memory ex511 is an element outside the LSI ex500 in the description, it may be included in the LSI ex500. The buffer ex508 is not limited to one buffer, but may be composed of buffers. Furthermore, the LSI ex500 may be made into one chip or a plurality of chips.

The name used here is LSI, but it may also be called IC, system LSI, super LSI, or ultra LSI depending on the degree of integration.

Moreover, ways to achieve the integration are not limited to the LSI, and a special circuit or a general purpose processor and so forth can also achieve the integration. Field Programmable Gate Array (FPGA) that can be programmed after manufacturing LSI or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. One such possibility is that the present invention is applied to biotechnology.

### (Other Modifications)

Although the present invention is described based on Embodiments, obviously, the present invention is not limited to these Embodiments. The present invention includes the following cases.

(1) Each of the above apparatuses is specifically a computer system including a microprocessor, a ROM, a RAM, a hard disk unit, a display unit, a keyboard, and a mouse. The RAM or the hard disk unit stores a computer program. The microprocessor operates according to the computer program, so that each of the apparatuses fulfills the function. Here, in order to fulfill a predetermined function, the computer program is programmed by combining instruction codes each indicating an instruction for a computer.

(2) Part or all of the constituent elements included in each of the above apparatuses may be included in one system large scale integration (LSI). The system LSI is a super-multifunctional LSI manufactured by integrating the constituent elements on one chip and is, specifically, a computer system including a micro processing unit, a ROM, and a RAM. The computer program is stored in the RAM. The micro processing unit operates according to the computer program, so that the system LSI fulfills its function.

(3) Part or all of the constituent elements included in each of the above apparatuses may be included in an IC card removable from each of the apparatuses or in a stand alone module. The IC card or the module is a computer system including a micro processing unit, a ROM, and a RAM. The IC card or the module may include the above super-multifunctional LSI. The micro processing unit operates according to the computer program, so that the IC card or the module fulfills its function. The IC card or the module may have tamper-resistance.

(4) The present invention may be any of the above methods. Furthermore, the present invention may be a computer program which causes a computer to execute these methods, and a digital signal included in the computer program.

Moreover, in the present invention, the computer program or the digital signal may be recorded on a computer-readable recording medium such as a flexible disk, a hard disk, a CD-ROM, an MO, a DVD, a DVD-ROM, a DVD-RAM, a Blu-ray Disc (BD), and a semiconductor memory. In addition, the present invention may be the digital signal recorded on these recording media.

Furthermore, in the present invention, the computer program or the digital signal may be transmitted via an electronic communication line, a wireless or wired communication line, a network represented by the Internet, data broadcasting, and the like.

Moreover, the present invention may be a computer system including a micro processing unit and a memory, wherein the memory may store the computer program and the micro processing unit may operate according to the computer program.

Furthermore, the present invention may execute the computer program or the digital signal in another independent computer system by recording the computer program or the digital signal on the recording medium and transporting the recording medium, or by transmitting the computer program or the digital signal via a network and the like.

(5) Embodiments and Modifications may be combined.

Although the image coding method, the image coding apparatus, the image decoding method, and the image decoding apparatus are described based on Embodiments according to the present invention, the present invention is not limited to these Embodiments. Without departing from the scope of the present invention, the present invention includes an embodiment with some modifications on Embodiments that are conceived by a person skilled in the art, and another embodiment obtained through combinations of the constituent elements and steps of different Embodiments in the present invention.

### INDUSTRIAL APPLICABILITY

The present invention is advantageously applicable to an image coding method (apparatus) and an image decoding method (apparatus).

### REFERENCE SIGNS LIST

11, 21, 61, 71, 2401 Quantized transformation coefficient block
12 Zig-zag scanning order
13, 22, 33, 506, 508 One-dimensional sequence
23, 66, 72, 1206, 1406, 1812, 2501, 2503 Binary sequence
24 Non-zero coefficient sequence
32 FSC scanning order
62 Tree structure
65 Zero-tree traversal order
73, 1203, 1403, 2002, 2003, 2004, 2005 Node
100 Moving image coding apparatus
105 Subtractor
110 Transform quantization unit
120 Inverse quantization/inverse transformation unit
125, 225 Adder
130, 230 Deblocking filter
140, 240 Memory
150, 250 Interpolation filter
160, 260 Motion compensated prediction unit
165 Motion estimation unit
170, 270 Intra-frame prediction unit
175, 275 Intra/inter switch
180 Sequence generating unit
190 Entropy coding unit
200 Moving image decoding apparatus
220 Inverse quantization/inverse transformation unit
280 Matrix generating unit
290 Entropy decoding unit
502 First scanning order
503 First coefficient sequence
504 Determination
505 Second scanning order
507 Third scanning order
1000 Structure information
1001 Tree structure determining unit
1002, 1004 Tree structure information
1003 Tree structure information memory
1005 Reference destination determining unit
1006, 1006a, 1006b, 1013 Reference destination information item
1007 Reference destination information memory
1009 Coefficient traversal unit
1009a Value assigning unit
1009b Traverse unit
1010 Two-dimensional matrix
1011 Trigger signal
1012 Information
1030 Transmission channel
1101 Data array
1102 Element
1103 Index pointer
1202, 1402, 1502, 1811, 2712, 2713, 2722, 2723, 2732, 2733, 2742, 2743 Zero-tree structure
1204, 1205, 1702 Subtree
1207 Partial sequence
1703 Conditional node
1704, 1705 Portion
1801 Zero-tree decoding unit
1802 Integrating unit
1803 Inverse quantization unit
1804 Inverse orthogonal transformation unit
1813 Levels and signs
1814 Position information item
1815 Integration signal
1816 Inverse quantized signal
1817 Signal
2000 Switching node
2209 Coefficient inverse traverse unit
2209a Inverse traverse unit
2209b Coefficient assigning unit
2402, 2403, 2405, 2702, 2704 Partial zero-tree structure
2502, 2504 Non-zero coefficient sequence
2703, 2706, 2708 Second partial zero-tree structure
2705, 2707, 2711, 2721, 2731, 2741 Coefficient position sequence
ex100 Content providing system
ex101 Internet
ex102 Internet service provider
ex103 Streaming server
ex104 Telephone network
ex102, ex107, ex108, ex109, ex102 Base station
ex111 Computer
ex112 PDA
ex113, ex116 Camera
ex114 Cellular phone equipped with camera (cellular phone)
ex115 Game machine
ex117 Microphone
ex200 Digital broadcasting system
ex201 Broadcast station
ex202 Broadcast satellite (satellite)
ex203 Cable
ex204, ex205, ex601 Antenna
ex210 Car
ex211 Car navigation system
ex212 Reproduction apparatus
ex213, ex219 Monitor
ex214, ex215, ex216, ex607 Recording medium
ex217 Set top box (STB)
ex218 Reader/recorder
ex220 Remote controller
ex230 Information track
ex231 Recording blocks
ex232 Inner circumference area
ex233 Data recording area
ex234 Outer circumference area
ex300 Television
ex301 Tuner
ex302 Modulation/demodulation unit
ex303 Multiplexing/demultiplexing unit
ex304 Audio signal processing unit
ex305 Video signal processing unit
ex306, ex507 Signal processing unit
ex307 Speaker
ex308, ex602 Display unit
ex309 Output unit
ex310, ex501 Control unit
ex311, ex505, ex710 Power supply circuit unit
ex312 Operation input unit
ex313 Bridge
ex314, ex606 Slot unit
ex315 Driver
ex316 Modem
ex317 Interface unit
ex318, ex319, ex320, ex321, ex404, ex508 Buffer
ex400 Information reproducing/recording unit
ex401 Optical head
ex402 Modulation recording unit
ex403 Reproduction demodulating unit
ex405 Disk motor
ex406 Servo control unit
ex407 System control unit
ex500 LSI
ex502 CPU
ex503 Memory controller
ex504 Stream controller
ex506 Stream I/O
ex509 AV I/O
ex510 Bus
ex511 Memory
ex603 Camera unit
ex604 Operation keys
ex605 Audio input unit
ex608 Audio output unit
ex701 Transmitting and receiving circuit unit
ex702 LCD control unit
ex703 Camera interface unit (camera I/F unit)
ex704 Operation input control unit
ex705 Audio processing unit
ex706 Modem circuit unit
ex707 Recording/reproducing unit
ex708 Multiplexing/demultiplexing unit
ex709 Image decoding unit
ex711 Main control unit
ex712 Image coding unit
ex713 Synchronous bus

1. A method of coding an image, said method comprising:
transforming pixel values of the image into a two-dimensional matrix including N coefficients in a frequency domain, where N is an integer equal to or larger than 2;
quantizing the N coefficients included in the two-dimensional matrix to generate N quantized coefficients;
generating a one-dimensional sequence based on the two-dimensional matrix including the N quantized coefficients and on tree structure information that defines a binary tree including a plurality of nodes including an internal node and N leaf nodes; and
coding the one-dimensional sequence generated in said generating, and at least some of the N quantized coefficients to generate a coded signal,
wherein said generating includes:
determining, based on the two-dimensional matrix, a reference destination information item indicating positions of the N quantized coefficients in the two-dimensional matrix to be referenced to by the N leaf nodes, respectively;
assigning one of a first value and a second value to each of the nodes of the binary tree defined by the tree structure information, based on the two-dimensional matrix and the reference destination information item, the first value being different from the second value; and
traversing the binary tree in preorder and arranging, in the preorder, the values assigned to the respective nodes to generate the one-dimensional sequence.

2. The method according to claim 1,
wherein in said assigning:
the first value is assigned to one of the N leaf nodes corresponding to a quantized coefficient to be coded in said coding, and the second value is assigned to an other one of the N leaf nodes corresponding to a quantized coefficient not to be coded in said coding, the quantized coefficient being held at a corresponding one of the positions of the two-dimensional matrix indicated in the reference destination information item; and
the first value is assigned to the internal node when the first value is assigned to at least one of two child nodes, and the second value is assigned to the internal node when the second value is assigned to both of the two child nodes,
in said traversing, when the second value is assigned to the internal node, traversing of a descendant node of the internal node is omitted, and
in said determining, the reference destination information item is determined so that the one-dimensional sequence generated in said traversing is shortest.

3. The method according to claim 2,
wherein further in said coding, the reference destination information item generated in said determining is coded when the reference destination information item is different from an immediately previous reference destination information item.

4. The method according to claim 1,
wherein the reference destination information item is an intermediate table for holding (i) position information items for identifying the positions of the two-dimensional matrix and (ii) indices for identifying the position information items, the position information items being associated with the indices, respectively, and
the tree structure information includes structure information for identifying a structure of the binary tree, and index information indicating the indices to be referenced to by the N leaf nodes, respectively, the indices being held in the intermediate table.

5. The method according to claim 4,
wherein in said determining, combinations of the positions of the two-dimensional matrix and the indices are changed so that one of the positions of the two-dimensional matrix at which a quantized coefficient to be coded is held is assigned to a leaf node that is traversed earlier than an other one of the positions of the two-dimensional matrix at which a quantized coefficient not to be coded is held.

6. The method according to claim 1,
wherein in said coding, all non-zero quantized coefficients among the N quantized coefficients are selected and coded.

7. The method according to claim 1,
wherein the two-dimensional matrix is divided into a first group of quantized coefficients and a second group of quantized coefficients, and
in said coding, all the quantized coefficients belonging to the first group are coded, and only a quantized coefficient selected out of the second group according to values of the quantized coefficients belonging to the first group is selected and coded.

8. A method of decoding a coded signal to generate an image from a coded signal using tree structure information that defines a binary tree including a plurality of nodes including an internal node and N leaf nodes, where N is an integer equal to or larger than 2, said method comprising:
decoding the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value;
generating the two-dimensional matrix including N quantized coefficients, based on the one-dimensional sequence, the one or more quantized coefficients, the reference destination information item, and the tree structure information;
inverse-quantizing the N quantized coefficients included in the two-dimensional matrix to generate N coefficients in a frequency domain; and
inverse-transforming the N coefficients to generate pixel values of the image,
wherein said generating includes:
traversing the binary tree in preorder, assigning values indicated in the one-dimensional sequence to the nodes, respectively, and omitting traversing of a descendant node of the internal node when the second value is assigned to the internal node; and
sequentially assigning, based on the reference destination information item, the one or more quantized coefficients to corresponding one or more of the positions of the two-dimensional matrix to be referenced to by corresponding one or more of the N leaf nodes to each of which the first value is assigned.

9. A coding apparatus that codes an image, said coding apparatus comprising:
a transformation unit configured to transform pixel values of the image into a two-dimensional matrix including N coefficients in a frequency domain, where N is an integer equal to or larger than 2;
a quantization unit configured to quantize the N coefficients included in the two-dimensional matrix to generate N quantized coefficients;
a sequence generating unit configured to generate a one-dimensional sequence based on the two-dimensional matrix including the N quantized coefficients and on tree structure information that defines a binary tree including a plurality of nodes including an internal node and N leaf nodes; and
a coding unit configured to code the one-dimensional sequence generated by said sequence generating unit, and at least some of the N quantized coefficients to generate a coded signal,
wherein said sequence generating unit includes:
a reference destination determining unit configured to determine, based on the two-dimensional matrix, a reference destination information item indicating positions of the N quantized coefficients in the two-dimensional matrix to be referenced to by the N leaf nodes, respectively;
a value assigning unit configured to assign one of a first value and a second value to each of the nodes of the binary tree defined by the tree structure information, based on the two-dimensional matrix and the reference destination information item, the first value being different from the second value; and
a traverse unit configured to traverse the binary tree in preorder and arrange, in the preorder, the values assigned to the respective nodes to generate the one-dimensional sequence.

10. A decoding apparatus that decodes a coded signal to generate an image from a coded signal using tree structure information that defines a binary tree including a plurality of nodes including an internal node and N leaf nodes, where N is an integer equal to or larger than 2, said decoding apparatus comprising:
a decoding unit configured to decode the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value;
a matrix generating unit configured to generate the two-dimensional matrix including N quantized coefficients, based on the one-dimensional sequence, the one or more quantized coefficients, the reference destination information item, and the tree structure information;
an inverse quantization unit configured to inverse-quantize the N quantized coefficients included in the two-dimensional matrix to generate N coefficients in a frequency domain; and
an inverse transformation unit configured to inverse-transform the N coefficients to generate pixel values of the image,
wherein said matrix generating unit includes:
an inverse traverse unit configured to traverse the binary tree in preorder, assign values indicated in the one-dimensional sequence to the nodes, respectively, and omit traversing of a descendant node of the internal node when the second value is assigned to the internal node; and
a coefficient assigning unit configured to sequentially assign, based on the reference destination information item, the one or more quantized coefficients to corresponding one or more of the positions of the two-dimensional matrix to be referenced to by corresponding one or more of the N leaf nodes to each of which the first value is assigned.

11. A non-transitory computer-readable recording medium on which a program causing a computer to code an image is recorded, the program causing the computer to execute:
transforming pixel values of the image into a two-dimensional matrix including N coefficients in a frequency domain, where N is an integer equal to or larger than 2;
quantizing the N coefficients included in the two-dimensional matrix to generate N quantized coefficients;
generating a one-dimensional sequence based on the two-dimensional matrix including the N quantized coefficients and on tree structure information that defines a binary tree including a plurality of nodes including an internal node and N leaf nodes; and
coding the one-dimensional sequence generated in the generating, and at least some of the N quantized coefficients to generate a coded signal,
wherein the generating includes:
determining, based on the two-dimensional matrix, a reference destination information item indicating positions of the N quantized coefficients in the two-dimensional matrix to be referenced to by the N leaf nodes, respectively;
assigning one of a first value and a second value to each of the nodes of the binary tree defined by the tree structure information, based on the two-dimensional matrix and the reference destination information item, the first value being different from the second value; and
traversing the binary tree in preorder and arranging, in the preorder, the values assigned to the respective nodes to generate the one-dimensional sequence.

12. A non-transitory computer-readable recording medium on which a program causing a computer to generate an image from a coded signal using tree structure information that defines a binary tree including a plurality of nodes including an internal node and N leaf nodes is recorded, where N is an integer equal to or larger than 2, the program causing the computer to execute:
decoding the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value;
generating the two-dimensional matrix including N quantized coefficients, based on the one-dimensional sequence, the one or more quantized coefficients, the reference destination information item, and the tree structure information;
inverse-quantizing the N quantized coefficients included in the two-dimensional matrix to generate N coefficients in a frequency domain; and
inverse-transforming the N coefficients to generate pixel values of the image,
wherein the generating includes:
traversing the binary tree in preorder, assigning values indicated in the one-dimensional sequence to the nodes, respectively, and omitting traversing of a descendant node of the internal node when the second value is assigned to the internal node; and
sequentially assigning, based on the reference destination information item, the one or more quantized coefficients to corresponding one or more of the positions of the two-dimensional matrix to be referenced to by corresponding one or more of the N leaf nodes to each of which the first value is assigned.

13. An integrated circuit that codes an image, said integrated circuit comprising:
a transformation unit configured to transform pixel values of the image into a two-dimensional matrix including N coefficients in a frequency domain, where N is an integer equal to or larger than 2;
a quantization unit configured to quantize the N coefficients included in the two-dimensional matrix to generate N quantized coefficients;
a sequence generating unit configured to generate a one-dimensional sequence based on the two-dimensional matrix including the N quantized coefficients and on tree structure information that defines a binary tree including a plurality of nodes including an internal node and N leaf nodes; and
a coding unit configured to code the one-dimensional sequence generated by said sequence generating unit, and at least some of the N quantized coefficients to generate a coded signal,
wherein said sequence generating unit includes:
a reference destination determining unit configured to determine, based on the two-dimensional matrix, a reference destination information item indicating positions of the N quantized coefficients in the two-dimensional matrix to be referenced to by the N leaf nodes, respectively;
a value assigning unit configured to assign one of a first value and a second value to each of the nodes of the binary tree defined by the tree structure information, based on the two-dimensional matrix and the reference destination information item, the first value being different from the second value; and
a traverse unit configured to traverse the binary tree in preorder and arrange, in the preorder, the values assigned to the respective nodes to generate the one-dimensional sequence.

14. An integrated circuit that generates an image from a coded signal using tree structure information that defines a binary tree including a plurality of nodes including an internal node and N leaf nodes, where N is an integer equal to or larger than 2, said integrated circuit comprising:
a decoding unit configured to decode the coded signal to generate (i) a one-dimensional sequence in which a first value and a second value are arranged in a predetermined order, (ii) a reference destination information item indicating positions of a two-dimensional matrix to be referenced to by the N leaf nodes, respectively, and (iii) one or more quantized coefficients, the first value being different from the second value;
a matrix generating unit configured to generate the two-dimensional matrix including N quantized coefficients, based on the one-dimensional sequence, the one or more quantized coefficients, the reference destination information item, and the tree structure information;
an inverse quantization unit configured to inverse-quantize the N quantized coefficients included in the two-dimensional matrix to generate N coefficients in a frequency domain; and
an inverse transformation unit configured to inverse-transform the N coefficients to generate pixel values of the image,
wherein said matrix generating unit includes:
an inverse traverse unit configured to traverse the binary tree in preorder, assign values indicated in the one-dimensional sequence to the nodes, respectively, and omit traversing of a descendant node of the internal node when the second value is assigned to the internal node; and
a coefficient assigning unit configured to sequentially assign, based on the reference destination information item, the one or more quantized coefficients to corresponding one or more of the positions of the two-dimensional matrix to be referenced to by corresponding one or more of the N leaf nodes to each of which the first value is assigned.
